(19) United States
(12) Patent Application Publication
(10) Pub. No.: US 2026/0129488 A1
(43) Pub. Date: May 7, 2026

(54) TECHNIQUES FOR EARLY CSI ACQUISITION IN LOWER LAYER TRIGGERED MOBILITY

(71) Applicant: QUALCOMM Incorporated, San Diego, CA (US)

(72) Inventors: Changhwan PARK, San Diego, CA (US); Jelena DAMNJANOVIC, Del Mar, CA (US); Wooseok NAM, San Diego, CA (US)

(21) Appl. No.: 18/939,372

(22) Filed: Nov. 6, 2024

(51) Int. Cl. H04W 24/10; H04L 5/00

(52) U.S. Cl. CPC H04W 24/10; H04L 5/0057; H04L 5/0078

(57) ABSTRACT

Methods, systems, and devices for wireless communications are described. A user equipment (UE) may receive, from a first cell, a message that triggers early channel state information (CSI) reporting for a second cell, and perform measurements for a CSI reference signal (CSI-RS) received from the second cell based on message, where the CSI-RS is received subsequent to the message in a time domain. The UE may transmit, to the first cell, the second cell, or both, a CSI report that is based on the measurements performed for the CSI-RS received from the second cell. The UE may then receive, from the first cell, a cell switch command to perform a cell switching procedure from the first cell to the second cell based on the CSI report.

### FIELD OF TECHNOLOGY

The following relates to wireless communications, including techniques for early channel state information (CSI) acquisition in lower layer triggered mobility (LTM).

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Wireless devices, such as UEs, may be configured to perform cell switching/reselection procedures to switch between different cells as the wireless devices move throughout a network. When evaluating whether or not to perform a cell switching procedure from one cell to another, a UE may perform measurements (e.g., RSRP, RSRQ) on synchronization signal blocks (SSBs) received from neighboring cells, and may transmit Layer 1 (L1) measurement reports back to the serving cell to assist with cell switching decisions.

### SUMMARY

The systems, methods, and devices of this disclosure each have several innovative aspects, no single one of which is solely responsible for the desirable attributes disclosed herein.

A method by a user equipment (UE) is described. The method may include receiving, from a first cell, a message that triggers early channel state information (CSI) reporting for a second cell, performing measurements for a CSI reference signal (CSI-RS) received from the second cell based on receiving the message, where the CSI-RS is received subsequent to the message in a time domain, transmitting, to the first cell, the second cell, or both, a CSI report that is based on the measurements performed for the CSI-RS received from the second cell, and receiving, from the first cell, a cell switch command to perform a cell switching procedure from the first cell to the second cell based on the CSI report.

A UE is described. The UE may include one or more memories storing processor executable code, and one or more processors coupled with the one or more memories. The one or more processors may individually or collectively be operable to execute the code to cause the UE to receive, from a first cell, a message that triggers early CSI reporting for a second cell, perform measurements for a CSI-RS received from the second cell based on receiving the message, where the CSI-RS is received subsequent to the message in a time domain, transmit, to the first cell, the second cell, or both, a CSI report that is based on the measurements performed for the CSI-RS received from the second cell, and receive, from the first cell, a cell switch command to perform a cell switching procedure from the first cell to the second cell based on the CSI report.

Another UE is described. The UE may include means for receiving, from a first cell, a message that triggers early CSI reporting for a second cell, means for performing measurements for a CSI-RS received from the second cell based on receiving the message, where the CSI-RS is received subsequent to the message in a time domain, means for transmitting, to the first cell, the second cell, or both, a CSI report that is based on the measurements performed for the CSI-RS received from the second cell, and means for receiving, from the first cell, a cell switch command to perform a cell switching procedure from the first cell to the second cell based on the CSI report.

A non-transitory computer-readable medium storing code is described. The code may include instructions executable by one or more processors to receive, from a first cell, a message that triggers early CSI reporting for a second cell, perform measurements for a CSI-RS received from the second cell based on receiving the message, where the CSI-RS is received subsequent to the message in a time domain, transmit, to the first cell, the second cell, or both, a CSI report that is based on the measurements performed for the CSI-RS received from the second cell, and receive, from the first cell, a cell switch command to perform a cell switching procedure from the first cell to the second cell based on the CSI report.

In some examples of the method, UEs, and non-transitory computer-readable medium described herein, a time interval between reception of the CSI-RS and transmission of the CSI report may be based on a time interval between reception of a downlink message via the first cell and transmission of an additional CSI report to the first cell.

Some examples of the method, UEs, and non-transitory computer-readable medium described herein may further include operations, features, means, or instructions for receiving, from the first cell, a medium access control-control element (MAC-CE) message that activates one or more transmission configuration indicator (TCI) states associated with the second cell, where the CSI-RS may be associated with the one or more TCI states.

Some examples of the method, UEs, and non-transitory computer-readable medium described herein may further include operations, features, means, or instructions for receiving, via the MAC-CE message, an indication of at least one TCI state from the one or more TCI states that may be to be used for early CSI reporting for the second cell, where the CSI-RS may be associated with the at least one TCI state.

In some examples of the method, UEs, and non-transitory computer-readable medium described herein, the CSI-RS may be configured for semi-persistent or aperiodic transmission and the method, apparatuses, and non-transitory computer-readable medium may include further operations, features, means, or instructions for receiving, via the MAC-CE message, an indication that transmission of the CSI-RS by the second cell may be activated or triggered.

Some examples of the method, UEs, and non-transitory computer-readable medium described herein may further include operations, features, means, or instructions for receiving, from the first cell, a second MAC-CE message, a downlink control information message, or both, that indicates at least one TCI state from the one or more TCI states that may be to be used for early CSI reporting for the second cell, where the CSI-RS may be associated with the at least one TCI state.

Some examples of the method, UEs, and non-transitory computer-readable medium described herein may further include operations, features, means, or instructions for receiving a synchronization signal block (SSB) from the second cell based on receiving the message that triggers early CSI reporting for the second cell, where the SSB may be quasi co-located with the CSI-RS, where the CSI-RS may be received based on receiving the SSB.

In some examples of the method, UEs, and non-transitory computer-readable medium described herein, the SSB may be received during a time interval following reception of the message that triggers early CSI reporting, the CSI-RS may be received after an expiration of the time interval, and the time interval may be associated with a processing time for the SSB at the UE.

In some examples of the method, UEs, and non-transitory computer-readable medium described herein, the CSI-RS may be one of a set of multiple periodic CSI-RSs transmitted by the second cell.

In some examples of the method, UEs, and non-transitory computer-readable medium described herein, a time interval between reception of the CSI-RS and transmission of the CSI report may be based on one or more capabilities associated with the UE.

In some examples of the method, UEs, and non-transitory computer-readable medium described herein, a time interval between reception of the CSI-RS and transmission of the CSI report may be based on a reference signal type associated with the CSI-RS, the reference signal type including one of a periodic reference signal, an aperiodic reference signal, or a semi-persistent reference signal.

In some examples of the method, UEs, and non-transitory computer-readable medium described herein, a time interval between reception of the CSI-RS and transmission of the CSI report may be based on whether the UE may have received an activation command for one or more TCI states associated with the second cell.

A method by a first cell is described. The method may include transmitting, to a UE, a message that triggers early CSI reporting for a second cell, transmitting, to a second cell, an indication for the second cell to transmit one or more CSI-RSs, receiving, from the UE, a CSI report that is based on a CSI-RS of the one or more CSI-RSs that is transmitted subsequent to the message in a time domain, and transmitting, to the UE, a cell switch command to perform a cell switching procedure from the first cell to the second cell based on the CSI report.

A first cell is described. The first cell may include one or more memories storing processor executable code, and one or more processors coupled with the one or more memories. The one or more processors may individually or collectively be operable to execute the code to cause the first cell to transmit, to a UE, a message that triggers early CSI reporting for a second cell, transmit, to a second cell, an indication for the second cell to transmit one or more CSI-RSs, receive, from the UE, a CSI report that is based on a CSI-RS of the one or more CSI-RSs that is transmitted subsequent to the message in a time domain, and transmit, to the UE, a cell switch command to perform a cell switching procedure from the first cell to the second cell based on the CSI report.

Another first cell is described. The first cell may include means for transmitting, to a UE, a message that triggers early CSI reporting for a second cell, means for transmitting, to a second cell, an indication for the second cell to transmit one or more CSI-RSs, means for receiving, from the UE, a CSI report that is based on a CSI-RS of the one or more CSI-RSs that is transmitted subsequent to the message in a time domain, and means for transmitting, to the UE, a cell switch command to perform a cell switching procedure from the first cell to the second cell based on the CSI report.

A non-transitory computer-readable medium storing code is described. The code may include instructions executable by one or more processors to transmit, to a UE, a message that triggers early CSI reporting for a second cell, transmit, to a second cell, an indication for the second cell to transmit one or more CSI-RSs, receive, from the UE, a CSI report that is based on a CSI-RS of the one or more CSI-RSs that is transmitted subsequent to the message in a time domain, and transmit, to the UE, a cell switch command to perform a cell switching procedure from the first cell to the second cell based on the CSI report.

In some examples of the method, first cells, and non-transitory computer-readable medium described herein, a time interval between the CSI-RS and the CSI report may be based on a time interval between transmission of a downlink message via the first cell and reception of an additional CSI report from the UE.

Some examples of the method, first cells, and non-transitory computer-readable medium described herein may further include operations, features, means, or instructions for transmitting, to the UE, a MAC-CE message that activates one or more TCI states associated with the second cell, where the CSI-RS may be associated with the one or more TCI states.

Some examples of the method, first cells, and non-transitory computer-readable medium described herein may further include operations, features, means, or instructions for transmitting, via the MAC-CE message, an indication of at least one TCI state from the one or more TCI states that may be to be used for early CSI reporting for the second cell, where the CSI-RS may be associated with the at least one TCI state.

Some examples of the method, first cells, and non-transitory computer-readable medium described herein may further include operations, features, means, or instructions for transmitting, to the UE, a second MAC-CE message, a downlink control information message, or both, that indicates at least one TCI state from the one or more TCI states that may be to be used for early CSI reporting for the second cell, where the CSI-RS may be associated with the at least one TCI state.

Some examples of the method, first cells, and non-transitory computer-readable medium described herein may further include operations, features, means, or instructions for receiving, from the UE, a capability message indicating one or more capabilities associated with the UE and transmitting an indication of the one or more capabilities of the UE, where a first time interval between the message that triggers early channels state information reporting and the CSI-RS, or a second time interval between the CSI-RS and the CSI report, may be based on the one or more capabilities.

In some examples of the method, first cells, and non-transitory computer-readable medium described herein, a time interval between the CSI-RS and the CSI report may be based on a reference signal type associated with the CSI-RS, the reference signal type including one of a periodic reference signal, an aperiodic reference signal, or a semi-persistent reference signal.

In some examples of the method, first cells, and non-transitory computer-readable medium described herein, a time interval between the CSI-RS and the CSI report may be based on whether the first cell may have transmitted an activation command for one or more TCI states associated with the second cell.

A method by a second cell is described. The method may include receiving, from a first cell, a message that indicates for the second cell to transmit one or more CSI-RSs to a UE for early CSI reporting at the UE, where the message indicates a timing associated with the one or more CSI-RSs, transmitting the one or more CSI-RSs to the UE based on receiving the message from the first cell and in accordance with the timing, and performing a cell switching procedure with the UE to switch the UE from the first cell to the second cell based on transmitting the one or more CSI-RSs.

A second cell is described. The second cell may include one or more memories storing processor executable code, and one or more processors coupled with the one or more memories. The one or more processors may individually or collectively be operable to execute the code to cause the second cell to receive, from a first cell, a message that indicates for the second cell to transmit one or more CSI-RSs to a UE for early CSI reporting at the UE, where the message indicates a timing associated with the one or more CSI-RSs, transmit the one or more CSI-RSs to the UE based on receiving the message from the first cell and in accordance with the timing, and perform a cell switching procedure with the UE to switch the UE from the first cell to the second cell based on transmitting the one or more CSI-RSs.

Another second cell is described. The second cell may include means for receiving, from a first cell, a message that indicates for the second cell to transmit one or more CSI-RSs to a UE for early CSI reporting at the UE, where the message indicates a timing associated with the one or more CSI-RSs, means for transmitting the one or more CSI-RSs to the UE based on receiving the message from the first cell and in accordance with the timing, and means for performing a cell switching procedure with the UE to switch the UE from the first cell to the second cell based on transmitting the one or more CSI-RSs.

A non-transitory computer-readable medium storing code is described. The code may include instructions executable by one or more processors to receive, from a first cell, a message that indicates for the second cell to transmit one or more CSI-RSs to a UE for early CSI reporting at the UE, where the message indicates a timing associated with the one or more CSI-RSs, transmit the one or more CSI-RSs to the UE based on receiving the message from the first cell and in accordance with the timing, and perform a cell switching procedure with the UE to switch the UE from the first cell to the second cell based on transmitting the one or more CSI-RSs.

Some examples of the method, second cells, and non-transitory computer-readable medium described herein may further include operations, features, means, or instructions for receiving, from the first cell, an indication of one or more capabilities of the UE, where the timing of the one or more CSI-RSs may be based on the one or more capabilities.

Some examples of the method, second cells, and non-transitory computer-readable medium described herein may further include operations, features, means, or instructions for transmitting an SSB to the UE based on receiving the message from the first cell, where the SSB may be quasi co-located with the one or more CSI-RSs, where the one or more CSI-RSs may be transmitted based on transmitting the SSB.

In some examples of the method, second cells, and non-transitory computer-readable medium described herein, the one or more CSI-RSs include a set of multiple periodic CSI-RSs transmitted by the second cell.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports techniques for early channel state information (CSI) acquisition in lower layer triggered mobility (LTM) in accordance with one or more aspects of the present disclosure.

FIG. 2 shows an example of a wireless communications system that supports techniques for early CSI acquisition in LTM in accordance with one or more aspects of the present disclosure.

FIG. 3 shows an example of a signaling diagram that supports techniques for early CSI acquisition in LTM in accordance with one or more aspects of the present disclosure.

FIG. 4 shows an example of a process flow that supports techniques for early CSI acquisition in LTM in accordance with one or more aspects of the present disclosure.

FIGS. 5 and 6 show block diagrams of devices that support techniques for early CSI acquisition in LTM in accordance with one or more aspects of the present disclosure.

FIG. 7 shows a block diagram of a communications manager that supports techniques for early CSI acquisition in LTM in accordance with one or more aspects of the present disclosure.

FIG. 8 shows a diagram of a system including a device that supports techniques for early CSI acquisition in LTM in accordance with one or more aspects of the present disclosure.

FIGS. 9 and 10 show block diagrams of devices that support techniques for early CSI acquisition in LTM in accordance with one or more aspects of the present disclosure.

FIG. 11 shows a block diagram of a communications manager that supports techniques for early CSI acquisition in LTM in accordance with one or more aspects of the present disclosure.

FIG. 12 shows a diagram of a system including a device that supports techniques for early CSI acquisition in LTM in accordance with one or more aspects of the present disclosure.

FIGS. 13 through 15 show flowcharts illustrating methods that support techniques for early CSI acquisition in LTM in accordance with one or more aspects of the present disclosure.

### DETAILED DESCRIPTION

Wireless devices, such as user equipments (UEs), may be configured to perform cell switching/reselection procedures to switch between different cells as the wireless devices move throughout a network. When evaluating whether or not to perform a cell switching procedure from one cell to another, a UE may perform measurements (e.g., reference signal received power (RSRP), reference signal received quality (RSRQ)) on synchronization signal blocks (SSBs) received from neighboring cells, and may transmit Layer 1 (L1) measurement reports back to the serving cell to assist with cell switching decisions.

Measurements performed on SSBs of neighboring cells enables the UE to perform time/frequency tracking for the neighboring cell, but does not enable the UE to evaluate other channel state information (CSI) metrics of the neighboring cells (e.g., rank indicator (RI), channel quality indicator (CQI), precoding matrix indicator (PMI)). As such, when using only SSBs, the UE may have to perform more complex CSI measurements upon switching to the neighboring cell, which may increase a latency of communications between the UE and the new cell. Some wireless networks may enable UEs to measure CSI reference signals (CSI-RSs) from the neighboring cells (in addition/alternate to SSBs) to determine CSI metrics that are used to evaluate potential cell switching procedures. However, the use of CSI-RSs to evaluate cell switching may result in increased processing complexity at the UE to perform fast Fourier transform (FFT) processing of the CSI-RSs when the serving cell and candidate cell are not time-synchronous.

Accordingly, aspects of the present disclosure are directed to techniques for utilizing CSI-RSs for early CSI reporting in lower layer triggered mobility (LTM). In particular, aspects of the present disclosure are directed to configurations and relationships between CSI-RSs, CSI reports, and triggers for early CSI reporting that are used to reduce the complexity and processing burden at the UE for early CSI reporting. Such configurations/relationships may enable UEs to know when to expect CSI-RSs for early CSI reporting, and when to transmit CSI reports for cell switching decisions, thereby reducing processing complexity at the UE.

For example, the UE may communicate with a serving cell, and may receive an trigger to perform early CSI reporting for a second, candidate cell (e.g., neighbor cell). The UE may then perform measurements for a CSI-RS received from the candidate cell, and transmit a CSI report to the serving cell to assist with cell switching decisions. In this example, a first time interval between the trigger and the CSI-RS, and/or a second time interval between the CSI-RS and the CSI report, may be pre-configured and/or based on UE capabilities. For instance, the UE may not expect to receive the CSI-RS until some time interval after the trigger for early CSI reporting, which may reduce the processing complexity for early CSI reporting at the UE. In some cases, the serving cell and the candidate cell may coordinate with one another regarding the relative timing of the trigger, the CSI-RSs, and the CSI report.

Aspects of the disclosure are initially described in the context of wireless communications systems. Additional aspects of the disclosure are further described in the context of an example signaling diagram and an example process flow. Aspects of the disclosure are further illustrated by and described with reference to apparatus diagrams, system diagrams, and flowcharts that relate to techniques for early CSI acquisition in LTM.

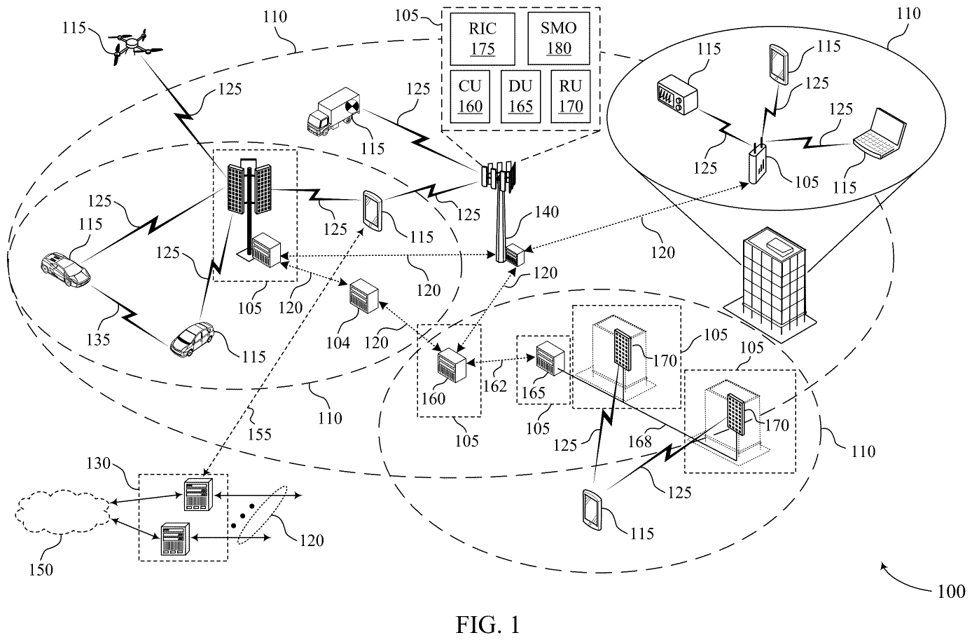

FIG. 1 shows an example of a wireless communications system 100 that supports techniques for early CSI acquisition in LTM in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support techniques for early CSI acquisition in LTM as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI-RS), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The respective devices of the wireless communications system 100 may support techniques for utilizing CSI-RSs for early CSI reporting in LTM. In particular, the wireless communications system 100 may support configurations and relationships between CSI-RSs, CSI reports, and triggers for early CSI reporting that are used to reduce the complexity and processing burden at the UEs 115 for early CSI reporting. Such configurations/relationships may enable UEs 115 of the wireless communications system 100 to know when to expect CSI-RSs for early CSI reporting, and when to transmit CSI reports for cell switching decisions, thereby reducing processing complexity at the UEs 15.

For example, a UE 115 of the wireless communications system 100 may communicate with a serving cell, and may receive an trigger to perform early CSI reporting for a second, candidate cell (e.g., neighbor cell). The UE 115 may then perform measurements for a CSI-RS received from the candidate cell, and transmit a CSI report to the serving cell to assist with cell switching decisions. In this example, a first time interval between the trigger and the CSI-RS, and/or a second time interval between the CSI-RS and the CSI report, may be pre-configured and/or based on UE 115 capabilities. For instance, the UE 115 may not expect to receive the CSI-RS until some time interval after the trigger for early CSI reporting, which may reduce the processing complexity for early CSI reporting at the UE 115. In some cases, the serving cell and the candidate cell may coordinate with one another regarding the relative timing of the trigger, the CSI-RSs, and the CSI report.

Techniques described herein may be used to facilitate more efficient cell switching procedures, and to reduce latency between UEs 115 and a new cell upon completion of a cell switching procedure. In particular, aspects of the present disclosure may enable UEs 115 to acquire CSI information from a candidate cell before and/or during an LTM switching procedure, thereby enabling the UE 115 to determine CSI information for the new cell before completing the LTM switching procedure. As such, techniques described herein may prevent the need for the UE 115 to acquire CSI information from the new cell after completion of the cell switching procedure, thereby reducing a latency of wireless communications. Further, the configuration and rules defined herein may enable UEs 115 to identify when to expect CSI-RSs from neighboring cells, and when to transmit CSI reports, thereby reducing the complexity and processing burden associated with CSI acquisition from neighboring cells. Thus, aspects of the present disclosure may reduce complexity and power consumption of the UEs 115, and improve battery life/performance.

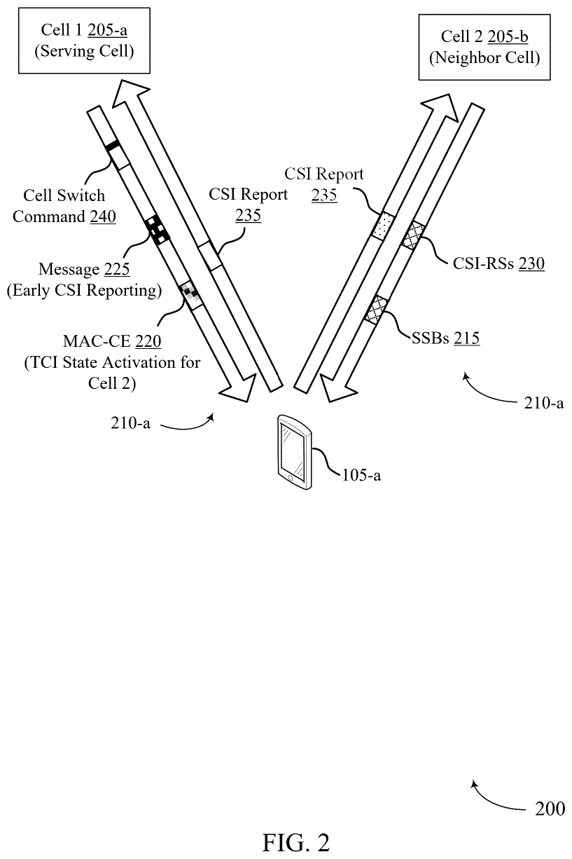

FIG. 2 shows an example of a wireless communications system 200 that supports techniques for early CSI acquisition in LTM in accordance with one or more aspects of the present disclosure. In some examples, aspects of the wireless communications system 200 may implement, or be implemented by, aspects of the wireless communications system 100. In particular, the wireless communications system 200 may support techniques for early CSI acquisition and reporting for LTM, as described herein.

The wireless communications system 200 may include a first serving cell 205-a, a second cell 205-b, and a UE 115-a. The cells 205 may be examples of primary cells (PCells), secondary cells (SCells), and the like, that facilitate wireless communications between the network and the UE 115-a. The first serving cell 205-a and the second cell 205-b may be associated with (e.g., supported by) one or more network entities 105. For example, as shown in FIG. 2, the first cell 205-a may be associated with (e.g., supported by) a first network entity 105, and the second cell 205-b may be associated with (e.g., supported by) a second network entity 105. In additional or alternative implementations, the first cell 205-a and the second cell 205-b may be associated with (e.g., supported by) the same network entity 105.

In some aspects, the cells 205 and the UE 115-a may communicate with one another using communication links 210-a, 210-b, which may examples of NR or LTE links, sidelink (e.g., PC5 links), and the like, between the respective devices. In some cases, the communication links 210 may include examples of access links (e.g., Uu links) which may include bi-directional links that enable both uplink and downlink communication. For example, the UE 115-a may transmit uplink signals, such as uplink control signals or uplink data signals, to the first cell 205-a (e.g., to one or more components of a network entity 105-a supporting the first cell 205-a) using the communication link 210-a, and the first cell 205-a (e.g., one or more components of the network entity 105-a supporting the first cell 205-a) may transmit downlink signals, such as downlink control signals or downlink data signals, to the UE 115-a using the communication link 210-a.

As noted previously herein, as UEs 115 move around within a network, the UEs 115 may be configured to switch from one cell 205 to another. Some wireless networks may support LTM (e.g., L1/L2 triggered mobility), where the UEs 115 and cells 205 exchange configuration and maintenance information for multiple candidate cells 205 to allow for fast application of configurations for candidate cells 205 (e.g., dynamic switching mechanisms among candidate serving cells 205, such as SPCells and SCells).

In the context of cell switching (e.g., LTM), the UE 115-a may be configured to perform cell switching/reselection procedures to switch between different cells 205 as the UE 115-a moves throughout the network. When evaluating whether or not to perform a cell switching procedure from the first cell 205-a to the second cell 205-b, the UE 115 may perform measurements (e.g., RSRP, RSRQ) on SSBs 215 received from the neighboring second cell 205-b, and may transmit L1 measurement reports back to the first cell 205-a to assist with cell switching decisions.

In this regard, LTM may generally provide techniques for inter-cell bema management, including L1 measurement and reporting, beam indications, and timing advance (TA) management. In some wireless communications systems, LTM may only be applicable for certain scenarios, such as: SSB-based L1 measurement; standalone, carrier aggregation (CA) and NR-DC cases with serving cell change within one CG (prioritizing MCG); intra-DU, intra-CU, and inter-DU cases; intra-frequency and inter-frequency cases; FR1 and FR2; cases where source and target cells 205 are synchronized or non-synchronized; PCell and SCell change in CA scenarios; dual connectivity scenarios; and scenarios with PCell and MCG SCell(s) change and intra-SN SpCell and SCG SCell(s) change without MN involvement. Moreover, in some wireless networks, LTM for simultaneous PCell and SpCell change is not supported.

Measurements performed on SSBs 215 of the neighboring cell 205-b enables the UE 115-a to perform time/frequency tracking for the neighboring cell 205-b, but does not enable the UE 115-a to evaluate other CSI metrics of the neighboring cell 205-b, such as RI, CQI, PMI, etc. As such, when using only SSBs 215, the UE 115-a may have to perform more complex CSI measurements upon switching to the neighboring cell 205-b, which may increase a latency of communications between the UE 115-a and the second cell 205-b.

LTM may be fully controlled by the network, such as via upfront RRC configuration without conditional handover (CHO) events. As will be described in further detail herein, LTM techniques implemented by some wireless networks may support L1 measurement and report (optional for FR1), early downlink sync (e.g., upfront time/frequency and beam sync via TCI activation), a unified TCI framework, and early uplink sync (e.g., upfront uplink time and beam sync via PDCCH-order PRACH with Msg1 and no random access response (RAR)). Further, in some cases, L2 signaling may be used to trigger handovers between cells 205.

Some wireless networks may enable UEs to measure CSI-RSs from the neighboring cells (in addition/alternate to SSBs) to determine CSI metrics that are used to evaluate potential cell switching procedures (e.g., CSI-RS based beam management). However, the use of CSI-RSs to evaluate cell switching may result in increased processing complexity at the UE to perform fast Fourier transform (FFT) processing of the CSI-RSs when the serving cell and candidate cell are not time-synchronous.

In particular, CSI-RS-based radio resource management (RRM) may utilize CSI-RSs for LTM, where CSI-RS resources for L3 can be more flexible than SSB in configuration of bandwidth and density and adopted for per-UE level mobility. Some networks may implement various RRM requirements for CSI-RS based L3 measurements. For example, single FFT may be assumed for multiple cell measurements per frequency layer for both intra-and inter-frequency measurements. Further, in the context of CSI-RS based RRM, due to constraint of single FFT, the UE 115-a may not be expected to handle cells 205 with larger timing difference for the intra-frequency measurements. Stated differently, CSI-RS based RRM may only be used between cells 205-a, 205-b that are synchronous, or otherwise exhibit small timing differences.

Comparing CSI-RS based beam management (e.g., L1-RSRP) against CSI acquisition, CSI parameters (e.g., RI, PMI, CQI, LI) may be derived based on the channel estimate of a respective cell 205 to maximize spectral efficiency. As such, acquisition of CSI parameters requires more than just time/frequency tracking of the target cell 205-b, as may be done with SSBs 215. In other words, SSBs 215 may not enable acquisition of CSI parameters.

In this regard, previous CSI-RS based CSI acquisition techniques suffer from two main issues or drawbacks: (1) FFT processing when the serving cell 205-a and target cell 205-b in the same frequency layer are not time-synchronous, and (2) accurate time/frequency tracking and channel statistics measurements for channel estimation require high complexity/processing resources at the UE 115-a. With respect to the first issue, UE 15-a CSI processing capability may be limited by the number of FFT engines available at the UE 115-a, per slot, to process CSI-RSs from cells 205 that are not asynchronous with each other. With respect to the second issue, UE 15-a CSI processing capability may be limited by the signal processing power after FFT per CSI-RS resource sets, per cell, etc. The processing power associated with processing CSIs of a target cell 205 may involve time/frequency tracking loops, channel characteristics tracking (e.g., power delay profile, Doppler spread, etc.), CSI-RS based channel estimation, and derivation of spectral efficiency over multi-dimensional hypothetical parameters (e.g., rank, PMI, etc.).

These two issues with previous CSI-RS based CSI acquisition techniques are partially attributable to the fact that the UE 115-a may not know when to expect CSI-RSs from neighboring cells 205, and/or when to transmit CSI reports for early CSI reporting. As such, these issues may be partially addressed, or otherwise alleviated, if a causality (e.g., trigger, timing relationship) between triggers for early CSI reporting and reference CSI-RS resource (including channel measurement resources (CMRs) and interference management resources (IMRs)) is ensured.

Accordingly, aspects of the present disclosure are directed to techniques for utilizing CSI-RSs for early CSI reporting in LTM. That is, aspects of the present disclosure may enable early CSI acquisition and reporting for candidate cells 205 based on CSI-RSs before and/or during LTM cell switch procedures. In particular, aspects of the present disclosure are directed to configurations and relationships between CSI-RSs, CSI reports, and triggers for early CSI reporting that are used to reduce the complexity and processing burden at the UE 115-a for early CSI reporting. Such configurations/relationships may enable the UE 115-a to know when to expect CSI-RSs from the second cell 205-b for early CSI reporting, and when to transmit CSI reports for cell switching decisions, thereby reducing processing complexity at the UE 115.

In this regard, aspects of the present disclosure are directed to “early CSI acquisition,” where the UE 115-a may acquire/measure CSI for the candidate cell 205-b (e.g., “CSI acquisition) based on CSI-RSs before or during an LTM cell switch from the first cell 20-a to the second cell 205-b. The early CSI measurement-related enhancements described herein may be applicable to Intra-CU MCG/SCG LTM and Inter-CU MCG/SCG LTM scenarios.

For example, referring to the wireless communications system 200 in FIG. 2, the UE 115-a may communicate with the current serving cell (e.g., first cell 205-a). For example, the UE 115-a may transmit measurement reports (e.g., L3 measurement reports) to the first cell 205-a, where the measurement reports may be associated with measurements performed on reference signals received from the first cell 205-a.

In some cases, the first cell 205-a and the second cell 205-b may exchange communications with one another for LTM preparation. In other words, the cells 205 may exchange signaling with one another to prepare for a possible cell switch/handover of the UE 115-a from the first cell 205-a to the second cell 205-b. In some aspects, the communications between the cells 205 may include information that enables early CSI acquisition/reporting at the UE 115-a for the second cell 205-b. For example, in some cases, the first cell 205-a may indicate, to the second cell 205-b, time/frequency resources for communicating SSBs 215 and/or CSI-RSs 230 for early CSI reporting. In some cases, the first cell 205-a may indicate one or more capabilities associated with the UE 115-a which are used by the second cell 205-b to determine a relative timing of the CSI-RSs 230 (where the UE 115-a may indicate the UE capabilities to the first cell 205-a via capability signaling).

In some aspects, as part of LTM preparation, the UE 115-a may perform measurements (e.g., L1 measurements) on the SSBs 215 received from the second cell 205-b. The L1 measurements may include L1-RSRP measurements, L1-RSRQ measurements, or both. The UE 115-a may perform the measurements of the SSBs 215 for time/frequency tracking of the second cell 205-b. In some cases, the UE 115-a may transmit a measurement report to the first cell 205-a, where the measurement report is be based on the measurements performed on the SSBs 215 received from the second cell 205-b. Such an L1 measurement report may be used to facilitate cell switch decisions for the UE 115-a (e.g., determine whether or not to trigger a cell switch from the first cell 205-a to the second cell 205-b).

The UE 115-a may receive a MAC-CE message 220 that indicates a TCI state activation for the second cell 405-. In other words, the MAC-CE message 220 may activate one or more TCI states associated with the second cell 205-b. For example, the MAC-CE message 220 may activate (and/or deactivate) a unified TCI state for the second cell 205-b.

In some aspects, the UE 115-a may receive a message 225 that triggers early CSI reporting for the second cell 205-b. The message 225 may include a MAC-CE message, a DCI message, an RRC message, or any combination thereof. For example, in some cases, the MAC-CE message 220 may include the trigger for early CSI reporting, in which case the MAC-CE message 220 and the message 225 may be the same message. The UE 115-a may receive the message 225 indicating the trigger for early CSI reporting based on the L1 measurement report transmitted to the first cell 205-a.

In some cases, the UE 115-a may receive an message (e.g., additional MAC-CE, DCI, etc.) that indicates which activated TCI state(s) are to be used for early CSI reporting and acquisition. For example, in cases where the MAC-CE message 220 activates a set of TCI states of the second cell 205-b, an additional message may indicate one (or more) TCI states from the set of activated TCI states that are to be used for early CSI reporting (e.g., indicate which TCI state(s) are associated with CSI-RSs 230 from the second cell 205-b).

The UE 115-a may receive one or more CSI-RSs 230 from the second cell 205-b for early CSI reporting/acquisition. The second cell 205-b may transmit the CSI-RSs 230 based on time/frequency information provided by the first cell 205-a via the communications between the respective cells. Further, in some cases, the CSI-RSs 230 may be associated with the activated TCI state(s) of the second cell 205-b which were activated via the MAC-CE message 220 (and/or indicated as being used for early CSI reporting via an additional message).

As noted previously herein, the UE 115-a may receive the CSI-RSs 230 for early CSI acquisition/reporting before and/or during an LTM cell switch to the second cell 205-b, which may reduce a latency of communications between the UE 115-a and the second cell 205-b in the event the UE 115-a is handed over to the second cell 205-b.

The UE 115-a may perform measurements on the CSI-RSs 230 received from the second cell 205-b. As noted previously herein, as compared to the measurements performed on the SSBs 215 which are used for time/frequency tracking, the measurements performed on the CSI-RSs 230 may be used to determine CSI metrics associated with the second cell 205-b, such as RI, PMIs, CQI, etc.

In some aspects, the CSI-RS(s) 230 used for early CSI reporting may be identified and/or received some time interval after the message 225 indicating the trigger for early CSI reporting. In other words, the UE 115-a may not monitor for (and/or receive) the CSI-RS(s) 230 used for early CSI reporting until some time interval after receiving the message 225/trigger for early CSI reporting. Stated differently, the UE 115-a may not expect or monitor for CSI-RSs 230 during some time interval following the message 225. In some cases, the time interval between the message 225/trigger for early CSI reporting and the CSI-RS(s) 230 used for early CSI reporting may be the same as a similar time interval/gap used for CSI reporting for the first cell 205-a. Further, in some cases, the duration of the time interval between the message 225 and the CSI-RSs 230 may be based on UE capability, and/or may be explicitly indicated to the UE 115-a.

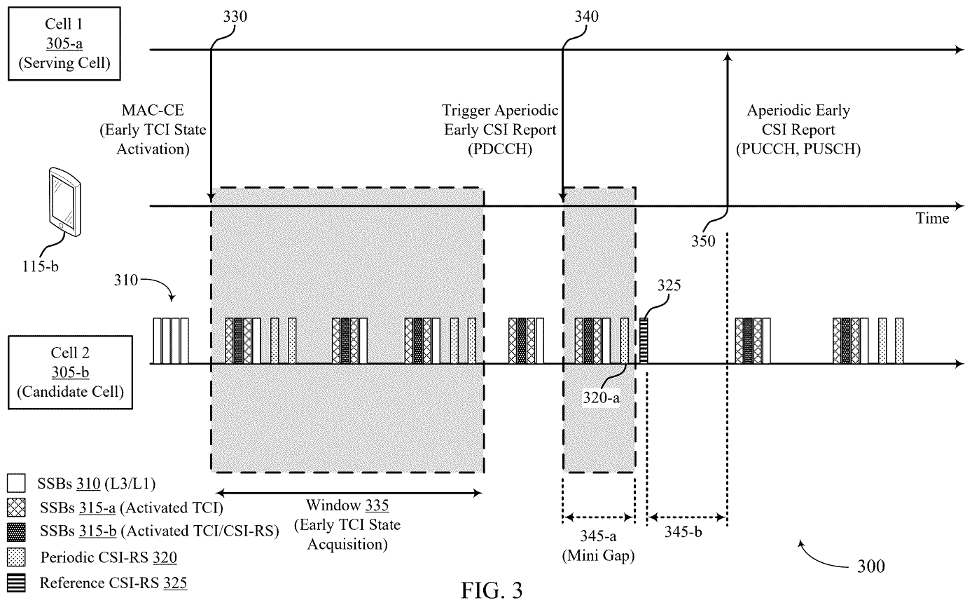

The temporal relationships (e.g., time interval) between the message 225 providing the trigger for early CSI reporting and the CSI-RSs used for early CSI reporting are further shown and described with respect to FIG. 3.

After receiving the CSI-RS(s) 230 for early CSI reporting/acquisition, the UE 115-a may transmit a CSI report 235 to the first cell 205-a, the second cell 205-b, or both, where the CSI report 235 is based on (e.g., includes) the CSI measurements performed on the CSI-RSs 230 from the second cell 205-b. Such CSI reports 235 may be used to make cell switch/handover decisions for the UE 115-a (e.g., determine whether or not the UE 115-a should switch from the first cell 205-a to the second cell 205-b).

In some aspects, the UE 115-a may transmit the CSI report 235 some time interval after receiving the CSI-RS 230 used for early CSI reporting. In other words, the UE 115-may not be expected to transmit the CSI report 235 until after a completion of a time interval following the CSI-RSs 230. In some cases, the time interval between the reference CSI-RSs 230 used for early CSI reporting and the CSI report 235 may be the same as a timing used for transmitting CSI reports 235 associated with the first cell 205-a. Further, in some cases, the duration of the time interval may be based on UE capability, and/or may be explicitly indicated to the UE 115-a.

The temporal relationships (e.g., time interval) between the CSI-RSs 230 used for early CSI reporting and the CSI report(s) 235 are further shown and described with respect to FIG. 3.

Subsequently, the UE 115-a may receive a cell switch command 240 (e.g., MAC-CE message) from the first cell 205-a, where the cell switch command 240 indicates/triggers a cell switching procedure of the UE 115-a from the first cell 205-a to the second cell 205-b. The UE 115-a may receive the cell switch command 240 at 485 based on transmitting the CSI report 235. In some cases, the cell switch command 240 may include a target cell ID associated with the second cell 205-b and/or TCI state activation. That is, the cell switch command 240 may indicate which TCI states are activated (and deactivated) for communicating with the second cell 205-b.

Based on the cell switch command 240, the UE 115-a, the first cell 205-a, and the second cell 205-b may perform a cell switch procedure (e.g., cell handover, LTM cell switch) to switch the UE 115-a from the first cell 205-a to the second cell 205-b. During the cell switch, the UE 115-a may detach from the first cell 205-a and apply configurations of the target/second cell 205-b (e.g., using the TA info and/or LTM candidate configuration). The respective devices may exchange various signaling and information between one another to perform the cell switch. For example, the UE 115-a may perform a RACH procedure with the second cell 205-b as part of the cell switch.

FIG. 3 shows an example of a signaling diagram 300 that supports techniques for early CSI acquisition in LTM in accordance with one or more aspects of the present disclosure. In some examples, aspects of the signaling diagram 300 may implement, or be implemented by, aspects of the wireless communications system 100, the wireless communications system 200, or both. In particular, the signaling diagram 300 may illustrate signaling used for early CSI acquisition and reporting for LTM, as described herein.

The signaling diagram 300 illustrates example signaling between a UE 115-b, a first cell 305-a, and a second cell 305-b, which may be examples of wireless devices as described herein. For example, the UE 115-b, the first cell 205-a, and the second cell 205-b illustrated in FIG. 3 may include examples of the UE 115-a, the first cell 205-a, and the second cell 205-b, respectively, as illustrated in FIG. 2. In this regard, the first cell 305-a may be an example of a current serving cell, and the second cell 305-b may be an example of neighboring cell or candidate cell. As described previously herein, the first cell 305-a and the second cell 305-b may be associated with (e.g., supported by) the same or different network entities.

In some aspects, as part of an LTM procedure, the UE 115-b may receive SSBs 310 from the second cell 305-b. For example, the SSBs 310 may be an example of the SSBs 315 shown and described in FIG. 2. The SSBs 310 may be configured for L3 or L1 measurement reports. That is, the SSBs 310 may be used for time/frequency tracking of the second cell 305-b, where the UE 115-b may transmit measurement reports (e.g., L1 measurement reports) to the first cell 305-a based on measurements performed on the SSBs 310.

The UE 115-b may receive a MAC-CE message 330 from the first cell 305-a, where the MAC-CE message 330 indicates an early TCI state activation for the second cell 305-b. In this regard, the MAC-CE message 330 in FIG. 3 may be an example of the MAC-CE message 220 in FIG. 2. The MAC-CE message 330 may trigger, initiate, or otherwise start/begin a window 335 for early TCI state acquisition for the second cell 305-b. That is, the UE 115-b may receive SSBs 315-a, 315-b from the second cell 305-b during the window 335, where the SSBs 315 are associated with the TCI state(s) activated via the MAC-CE message 330 in order to enable early TCI state acquisition by the UE 115-b.

In some cases, the first set of SSBs 315-a may be associated with early activated TCI states, and the second set of SSBs 315-b may be associated with the early activated TCI sates and CSI-RS resource(s) configurated for early CSI acquisition/reporting. The SSBs 315 may be communicated via periodic SSB resources.

The UE 115-b may receive a message 340 that triggers early CSI reporting/acquisition for the second cell 305-b. In this regard, the message 340 in FIG. 3 may be an example of the message 225 in FIG. 2.

In response to the trigger, the UE 115-b may perform measurements for a “reference” CSI-RS 325 that follows the message 340 in the time domain. The reference CSI-RS 325 may be included within a set of periodic CSI-RSs 320. For example, as shown in FIG. 3, the second cell 305—may transmit periodic CSI-RSs 320 prior to the message 340 triggering early CSI reporting, such as within the window 335. However, the UE 115-b may not be able or expected to perform measurements on any CSI-RSs until after an expiration/completion of a first time interval 345-a following the message 340. That is, the “reference” CSI-RS 325 resource used for early CSI reporting may be certain gap (e.g., first time interval 345-a) after the message 340 that triggers early CSI reporting. In some aspects, the duration of the first time interval 345-a (e.g., gap) may be based on one or more capabilities, which may be signaled to the first cell 305-a and/or the second cell 305-b. Further, in some cases, the duration of the first time interval 345-a may be explicitly indicated to the UE 115-b (and/or the second cell 305—).

For instance, as shown in FIG. 3, there may be a periodic CSI-RS 320-a resource following the message 340 but within the first time interval 345-a. in this regard, the UE 115-b may not be expected or able to receive/measure the CSI-RS 320-a due to the fact that the CSI-RS 320-a is within the time interval (e.g., based on the CSI-RS 320-a occurring too shortly after the message 340). As such, the UE 115-b may refrain from monitoring, receiving, or otherwise measuring CSI-RSs for the purposes of early CSI reporting until the reference CSI-RS 325. In additional or alternative cases, the “reference” CSI-RS 325 may be communicated via an aperiodic CSI-RS resource. In some cases, the first cell 305-a may indicate the time/frequency resources used to communicate the CSI-RSs 325, 330.

As noted previously herein, as compared to the measurements performed on the SSBs 310 315 which are used for time/frequency tracking, the measurements performed on the CSI-RS 325 may be used to determine CSI metrics associated with the second cell 305-b, such as RI, PMIs, CQI, etc. In this regard, the CSI report 350 may be used to evaluate a cell switch to the second cell 305-b, and may trigger the first cell 305-a to transmit a cell switch command to trigger a cell switch to the second cell 305-b (as shown and described with respect to the cell switch command 240 in FIG. 2).

Continuing with reference to FIG. 3, the UE 115-b may transmit a CSI report 350 to the first cell 305-a (and/or the second cell 305-b), where the CSI report 235 is based on (e.g., includes) the CSI measurements performed on the “reference” CSI-RS 325 from the second cell 305-b. The CSI report 350 may be used to make cell switch/handover decisions for the UE 115-b (e.g., determine whether or not the UE 115-b should switch from the first cell 305-a to the second cell 305-b).

In some aspects, the CSI report 350 may be a certain gap (e.g., second time interval 345-b) after the reference CSI-RS 325 resource. The duration of the gap/second time interval 345-b may be based on one or more factors. For example, in cases where there is early TCI state activation for the second cell 305-b (e.g., in cases with the MAC-CE message 330 indicating early TCI state activation), the CSI report 350 may be transmitted after the early TCI stat activation, as shown in FIG. 3. In such cases, the minimum length/duration of the second time interval 345-b/gap may be the same as aperiodic CSI reports communicated with the first cell 305-a (which incorporates PDCCH decoding latency and uplink channel (e.g., PUCCH or PUSCH) generation for CSI reports). Stated differently, the time interval 345-b may be the same as a corresponding time interval between CSI-RSs and CSI reports communicated for CSI reporting of the first cell 305-a.

In cases where there is early TCI state activation for the second cell 305-b (e.g., in cases with the MAC-CE message 330 indicating early TCI state activation), reference CSI-RS 325 for the early CSI report 350 may be associated with the TCI state(s) that were previously activated by the MAC-CE message 330. As such, the UE 115-b may be expected to keep tracking/collecting the required channel statistics of the source reference signals (e.g., SSBs 315) of the early activated TCI state of the second cell 305-b.

In some cases, activation of a large quantity of TCI states for the second cell 305-b may result in overloaded UE processing. Stated differently, the quantity of early activated TCI states may exceed the quantity of supported/configured CSI-RSs for CSI acquisition. In order to avoid such an issue of overloaded UE processing, the MAC-CE message 330 activating the early TCI states may additionally indicate which TCI state(s) may be connected with (e.g., used for) the early CSI reporting. That is, the MAC-CE message 330 may indicate a subset of activated TCI state(s) that will be used for communicating the CSI-RSs 320, 325 for early CSI reporting. In additional or alternative implementations, a DCI message or separate MAC-CE message (separate from the MAC-CE message 330 activating the TCI states) may be used to indicate the TCI states (among the activated TCI states) that are to be used for early CSI reporting. The UE capability of the number of early TCI states can be equal to or larger than the early CSI acquisition processes.

In some implementations, early TCI state activation (e.g., via the MAC-CE message 330) for the CSI acquisition may or may not be a prerequisite for early CSI acquisition/reporting. The lengths/durations of the time intervals 345 may be different based on whether or not there is early TCI state activation.

In other cases without early TCI state activation before the message 340 triggering early CSI reporting (e.g., in cases without the MAC-CE message 330 indicating activated TCI states), the reference CSI-RS 325 resource(s) associated with the triggered early CSI report 350 may be positioned after the quasi co-located (QCL'ed) SSBs 315 within the first time interval 345-a/gap (where the first time interval 345-a/gap may be based on UE SSB processing time, which is typically assumed to be 2 ms after the end of the SSB 315). Stated differently, in cases without early TCI state activation, the UE 115-b may be expected to receive/measure SSBs 315 (for TCI state acquisition) after receiving the message 340 triggering early CSI reporting, and before receiving/measuring the reference CSI-RS 325. In such cases, the first time interval 345-a may be configured to provide the UE 115-b with sufficient time to receive/process SSBs 315 for TCI state acquisition before receiving/processing the reference CSI-RS 325 (e.g., end of first time interval 345-a may be at least 2 ms after the end of the SSB(s) 315 within the first time interval 345-a).

In some aspects, the lengths/durations of the first time interval 345-a and/or the second time interval 345-b may be determined, signaled, or otherwise coordinated between the UE 115-b, the first cell 305-a, and the second cell 305-b. For instance, the first cell 305-a may request/instruct the candidate second cell 305-b to transmit aperiodic CSI-RS 325 at a specific time (e.g., within indicated time resources), and may also notify the UE 115-b to receive the aperiodic CSI-RS 325 for early CSI measurement/reporting.

Moreover, in some cases, the lengths/durations of the first time interval 345-a and/or the second time interval 345-b may be based on other parameters or characteristics, such as the type of the CSI-RSs, UE capabilities, and the like. For example, the UE 115-b may have varying capabilities for processing different types of CSI-RSs (e.g., periodic CSI-RS, aperiodic CSI-RS, semi-persistent CSI-RS). As such, the second time interval 345-b/gap between the CSI-RS 325 and the CSI report 350 may be different depending on the type of CSI-RS(s).

As noted previously herein, the CSI report 350 for early CSI acquisition/measurement may be transmitted before, during, or after an LTM procedure (e.g., CSI report 350 may be transmitted before or after LTM cell switch command). In such cases, the length/duration of the second time interval 345-b between the CSI-RS 325 and CSI report 350 may be different based on whether the CSI report 350 is transmitted before or after the cell switch command. In some cases, the causality between the CSI report 350 and the reference CSI-RS 325 resource may not be expected if the CSI report 350 and the reference CSI-RS 325 resource are communicated after reception of an LTM cell switch command.

For the purposes of the present disclosure, any parameters, rules, or other configurations that are used to determine the length/duration of the second time interval 345-b may also be applied to the first time interval 345-a, and vice versa.

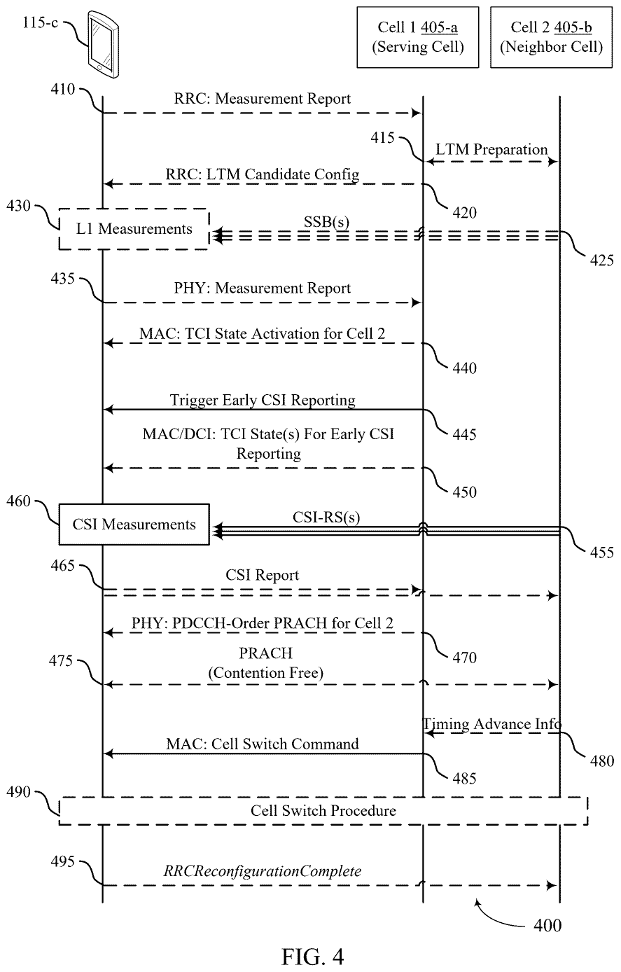

FIG. 4 shows an example of a process flow 400 that supports techniques for early CSI acquisition in LTM in accordance with one or more aspects of the present disclosure. In some examples, aspects of the process flow 400 may implement, or be implemented by, aspects of the wireless communications system 100, the wireless communications system 200, the signaling diagram 300, or any combination thereof. In particular, the process flow 400 may illustrate signaling used for early CSI acquisition and reporting for LTM, as described herein.

The process flow 400 includes a UE 115-c, a first cell 405-a, and a second cell 405-b, which may be examples of wireless devices as described herein. For example, the UE 115-c, the first cell 405-a, and the second cell 405-b illustrated in FIG. 4 may include examples of the UEs 115-a, 115-b, the first cell 205-a, 305-a, and the second cell 205-b, 305-b, respectively, as illustrated in FIGS. 2 and 3. In this regard, the first cell 405-a may be an example of a current serving cell, and the second cell 405-b may be an example of neighboring cell or candidate cell. As described previously herein, the first cell 405-a and the second cell 405-b may be associated with (e.g., supported by) the same or different network entities.

In some examples, the operations illustrated in process flow 400 may be performed by hardware (e.g., including circuitry, processing blocks, logic components, and other components), code (e.g., software or firmware) executed by a processor, or any combination thereof. Alternative examples of the following may be implemented, where some steps are performed in a different order than described or are not performed at all. In some cases, steps may include additional features not mentioned below, or further steps may be added.

At 410, the UE 115-c may transmit a measurement report (e.g., L3 measurement report) to the first cell 405-a. The measurement report may be associated with measurements performed on reference signals received from the first cell 405-a.

At 415, the first cell 405-a and the second cell 405-b may exchange communications with one another for LTM preparation. In other words, the cells 405 may exchange signaling with one another to prepare for a possible cell switch/handover of the UE 115-c from the first cell 405-a to the second cell 405-b.

In some aspects, the communications between the cells 405 at 415 (and/or subsequent communications between the cells) may include information that enables early CSI acquisition/reporting at the UE 115-c for the second cell 405-b. For example, in some cases, the first cell 405-a may indicate, to the second cell 405-b, time/frequency resources for communicating SSBs and/or CSI-RSs for early CSI reporting. In some cases, the first cell 405-a may indicate one or more capabilities associated with the UE 115-c which are used by the second cell 405-b to determine a relative timing of the CSI-RSs.

At 420, the UE 115-c may receive an LTM candidate configuration associated with the second cell 405-b (e.g., RRC reconfiguration). The LTM candidate configuration may include information for communicating with the second cell 405-b in order to evaluate a possible cell switch to the second cell 405-b.

At 425, the second cell 405-b may transmit SSBs to the UE 115-c. For example, the second cell 405-b may transmit the SSBs 215 shown and described in FIG. 2, and/or the SSBs 310 shown and described in FIG. 3. The second cell 405-b may transmit the SSBs at 425 based on the communications with the first cell 405-a at 415.

At 430, the UE 115-c may perform measurements (e.g., L1 measurements) on the SSBs received from the second cell 405-b. The L1 measurements may include L1-RSRP measurements, L1-RSRQ measurements, or both. In some cases, L1-RSRP measurements for the LTM candidate cell (e.g., second cell 405-b) may be optional for FR1. As noted previously herein, the UE 115-c may perform the measurements of the SSBs for time/frequency tracking of the second cell 405-b (e.g., time/frequency tracking for non-serving cells 205). That is, SSB-based L1-RSRP measurements may be based on the measurement period, measurement accuracy, and measurement/scheduling restrictions.

At 435, the UE 115-c may transmit a measurement report to the first cell 405-a. The measurement report may be based on the measurements performed on the SSBs received from the second cell 405-b at 430. As noted previously herein, the measurement report may be used to facilitate cell switch decisions for the UE 115-c (e.g., determine whether or not to trigger a cell switch from the first cell 405-a to the second cell 405-b).

At 440, the UE 115-c may receive a MAC-CE message that indicates a TCI state activation for the second cell 405-b. In other words, the MAC-CE message at 440 may activate one or more TCI states associated with the second cell 405-b. For example, the MAC-CE may activate (and/or deactivate) a unified TCI state for the second cell 405-b. In some aspects, the first cell 405-a may transmit the TCI state activation at 440 based on the measurement report at 435. In some aspects, the TCI activation at 440 may be performed as part of an early downlink synchronization for LTM with the second cell 405-b. There may be some TCI state activation latency (based on SSB, not CSI-RS) for early LTM TCI state activation.

At 445, the UE 115-c may receive a message that triggers early CSI reporting for the second cell 405-b. For example, as shown in FIG. 3, the UE 115-c may receive a message 340 that triggers an aperiodic early CSI report. The message may include a MAC-CE message, a DCI message, an RRC message, or any combination thereof. For example, in some cases, the MAC-CE message at 440 may include the trigger for early CSI reporting. The UE 115-c may receive the message indicating the trigger for early CSI reporting at 445 based on the measurement report at 435.

At 450, the UE 115-c may receive a message (e.g., additional MAC-CE, DCI, etc.) that indicates which activated TCI state(s) are to be used for early CSI reporting and acquisition. For example, in cases where the MAC-CE message at 440 activates a set of TCI states of the second cell 405-b, the message at 450 may indicate one (or more) TCI states from the set of activated TCI states that are to be used for early CSI reporting (e.g., indicate which TCI state(s) are associated with CSI-RSs from the second cell 405-b).

At 455, the second cell 405-b may transmit one or more CSI-RSs to the UE 115-c. The second cell 405-b may transmit the CSI-RSs based on time/frequency information provided by the first cell 405-a via the communications at 415. Further, in some cases, the CSI-RSs may be associated with the activated TCI state(s) of the second cell 405-b which were activated at 440 and/or indicated as being used for early CSI reporting at 450.

At 460, the UE 115-c may perform measurements on the CSI-RSs received from the second cell 405-b. As noted previously herein, as compared to the measurements performed on the SSBs at 430 which are used for time/frequency tracking, the measurements performed on the CSI-RSs at 460 may be used to determine CSI metrics associated with the second cell 405-b, such as RI, PMIs, CQI, etc.

In some aspects, the CSI-RS(s) used for early CSI reporting may be identified and/or received some time interval (e.g., time interval 345-a) after the message indicating the trigger for early CSI reporting 445. In other words, the UE 115-c may not monitor for (and/or receive) the CSI-RS(s) used for early CSI reporting until some time interval after receiving the trigger for early CSI reporting. For instance, as shown in FIG. 3, the reference CSI-RS that is measured for early CSI reporting may be received after an end of the time interval 345-a that follows the message 340 (e.g., reference CSI-RS resource is some gap after the CSI report trigger). Stated differently, the UE 115-c may not expect or monitor for CSI-RSs during the time interval 345-a following the message 340 (e.g., message at 445). In some cases, the time interval 345-a between the trigger for early CSI reporting and the reference CSI-RS resource may be the same as a similar gap used for CSI reporting for the first cell 405-a. Further, in some cases, the duration of the time interval 345-a may be based on UE capability. Moreover, in some cases, the duration of the time interval 345-a (and/or the exact time/frequency resources for the CSI-RSs) may be explicitly indicated to the UE 115-c.

At 465, the UE 115-c may transmit a CSI report to the first cell 405-a, the second cell 405-b, or both, where the CSI report is based on (e.g., includes) the CSI measurements performed at 460. As noted previously herein, the CSI report may be used to make cell switch/handover decisions for the UE 115-c (e.g., determine whether or not the UE 115-c should switch from the first cell 405-a to the second cell 405-b).

In some aspects, the UE 115-c may transmit the CSI report at 465 some time interval (e.g., time interval 345-b) after receiving the CSI-RS (e.g., reference CSI-RS 325) used for early CSI reporting. In other words, the UE 115—may not be expected to transmit the CSI report until after a completion of a time interval 345-b following the reference CSI-RS 325. In some cases, the time interval 345-b between the reference CSI-RS 325 and the CSI report may be the same as a timing used for transmitting CSI reports associated with the first cell 405-a. Further, in some cases, the duration of the time interval 345-b may be based on UE capability. Moreover, in some cases, the duration of the time interval 345-b (and/or the exact time/frequency resources for the CSI report) may be explicitly indicated to the UE 115-c.

At 470, the UE 115-c may receive, from the first cell 405-a, a PDCCH order to perform a physical random access (PRACH) procedure with the second cell 405-b. The UE 115-c may receive the PDCCH order at 470 based on transmitting the measurement report at 435, transmitting the CSI report at 465, or both.

At 480, the UE 115-c and the second cell 405-b may exchange signaling associated with a PRACH procedure between the devices (e.g., contention-free PRACH procedure). In some cases, PRACH retransmission may may be triggered by the PDCCH order.

At 485, the UE 115-c may receive TA information from the second cell 405-b. The UE 115-c may receive the TA information at 480 based on performing the PRACH procedure at 475. Additionally, or alternatively, the UE 115-c may perform autonomous TA estimation.

In some aspects, the signaling at 470, 475, and 480 may be performed as part of an early uplink synchronization procedure between the UE 115-c and the second cell 405-b.

At 485, the UE 115-c may receive a cell switch command (e.g., MAC-CE message) from the first cell 405-a, where the cell switch command indicates/triggers a cell switching procedure of the UE 115-c from the first cell 405-a to the second cell 405-b. The UE 115-c may receive the cell switch command at 485 based on transmitting the measurement report at 435, transmitting the CSI report at 465, performing the PRACH procedure at 475, or any combination thereof. In some cases, the cell switch command may include a target cell ID associated with the second cell 405-b and/or TCI state activation. That is, the cell switch command may indicate which TCI states are activated (and deactivated) for communicating with the second cell 405-b. In cases for RACH-less cell switching, the cell switch command may include a TA command (otherwise, the cell switch command may include RACH information).

At 490, the UE 115-c, the first cell 405-a, and the second cell 405-b may perform a cell switch procedure (e.g., cell handover, LTM cell switch) to switch the UE 115-c from the first cell 405-a to the second cell 405-b. During the cell switch, the UE 115-c may detach from the first cell 405-a and apply configurations of the target/second cell 405-b (e.g., using the TA info and/or LTM candidate configuration). The respective devices may exchange various signaling and information between one another to perform the cell switch. For example, the UE 115-c may perform a RACH procedure with the second cell 405-b as part of the cell switch. Moreover, the devices may perform the cell switch procedure at 490 based on the signaling at 415, the measurement report at 435, the CSI report at 465, the PRACh procedure at 475, the TA info at 480, the cell switch command at 485, or any combination thereof.

At 495, the UE 115—may transmit an RRC complete message (e.g., RRCReconfigurationComplete message) to the second cell 405-b upon completion of the cell switch procedure/RACH procedure.

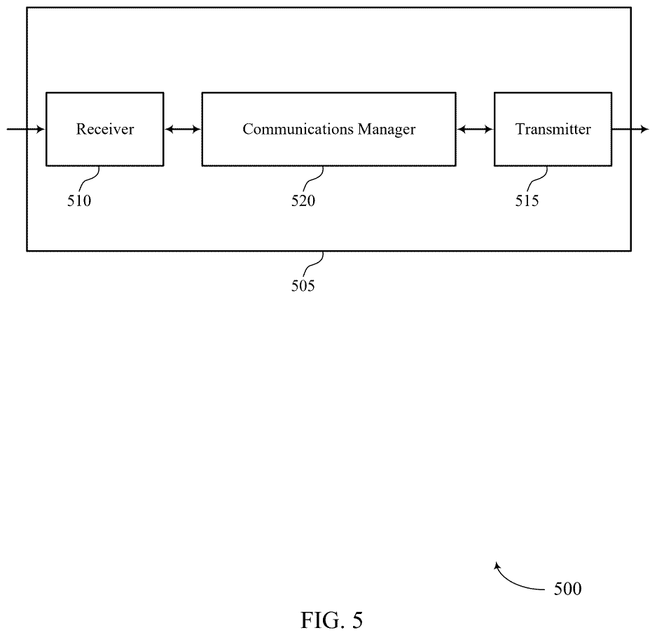

FIG. 5 shows a block diagram 500 of a device 505 that supports techniques for early CSI acquisition in LTM in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to, individually or collectively, support or enable the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to techniques for early CSI acquisition in LTM). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to techniques for early CSI acquisition in LTM). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations or components thereof may be examples of means for performing various aspects of techniques for early CSI acquisition in LTM as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 520, the receiver 510, the transmitter 515, or various combinations or components thereof may be implemented in code (e.g., as communications management software or firmware) executed by at least one processor (e.g., referred to as a processor-executable code). If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

For example, the communications manager 520 is capable of, configured to, or operable to support a means for receiving, from a first cell, a message that triggers early CSI reporting for a second cell. The communications manager 520 is capable of, configured to, or operable to support a means for performing measurements for a CSI-RS received from the second cell based on receiving the message, where the CSI-RS is received subsequent to the message in a time domain. The communications manager 520 is capable of, configured to, or operable to support a means for transmitting, to the first cell, the second cell, or both, a CSI report that is based on the measurements performed for the CSI-RS received from the second cell. The communications manager 520 is capable of, configured to, or operable to support a means for receiving, from the first cell, a cell switch command to perform a cell switching procedure from the first cell to the second cell based on the CSI report.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques to facilitate more efficient cell switching procedures, and to reduce latency between UEs 115 and a new cell upon completion of a cell switching procedure. In particular, aspects of the present disclosure may enable UEs 115 to acquire CSI information from a candidate cell before and/or during an LTM switching procedure, thereby enabling the UE 115 to determine CSI information for the new cell before completing the LTM switching procedure. As such, techniques described herein may prevent the need for the UE 115 to acquire CSI information from the new cell after completion of the cell switching procedure, thereby reducing a latency of wireless communications. Further, the configuration and rules defined herein may enable UEs 115 to identify when to expect CSI-RSs from neighboring cells, and when to transmit CSI reports, thereby reducing the complexity and processing burden associated with CSI acquisition from neighboring cells. Thus, aspects of the present disclosure may reduce complexity and power consumption of the UEs 115, and improve battery life/performance.

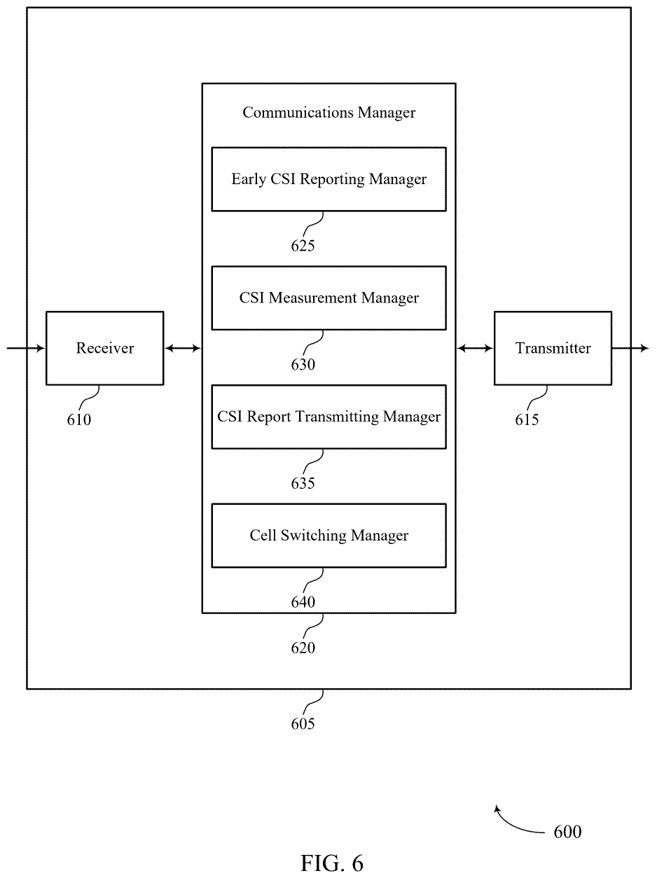

FIG. 6 shows a block diagram 600 of a device 605 that supports techniques for early CSI acquisition in LTM in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to techniques for early CSI acquisition in LTM). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to techniques for early CSI acquisition in LTM). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of techniques for early CSI acquisition in LTM as described herein. For example, the communications manager 620 may include an early CSI reporting manager 625, a CSI measurement manager 630, a CSI report transmitting manager 635, a cell switching manager 640, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The early CSI reporting manager 625 is capable of, configured to, or operable to support a means for receiving, from a first cell, a message that triggers early CSI reporting for a second cell. The CSI measurement manager 630 is capable of, configured to, or operable to support a means for performing measurements for a CSI-RS received from the second cell based on receiving the message, where the CSI-RS is received subsequent to the message in a time domain. The CSI report transmitting manager 635 is capable of, configured to, or operable to support a means for transmitting, to the first cell, the second cell, or both, a CSI report that is based on the measurements performed for the CSI-RS received from the second cell. The cell switching manager 640 is capable of, configured to, or operable to support a means for receiving, from the first cell, a cell switch command to perform a cell switching procedure from the first cell to the second cell based on the CSI report.

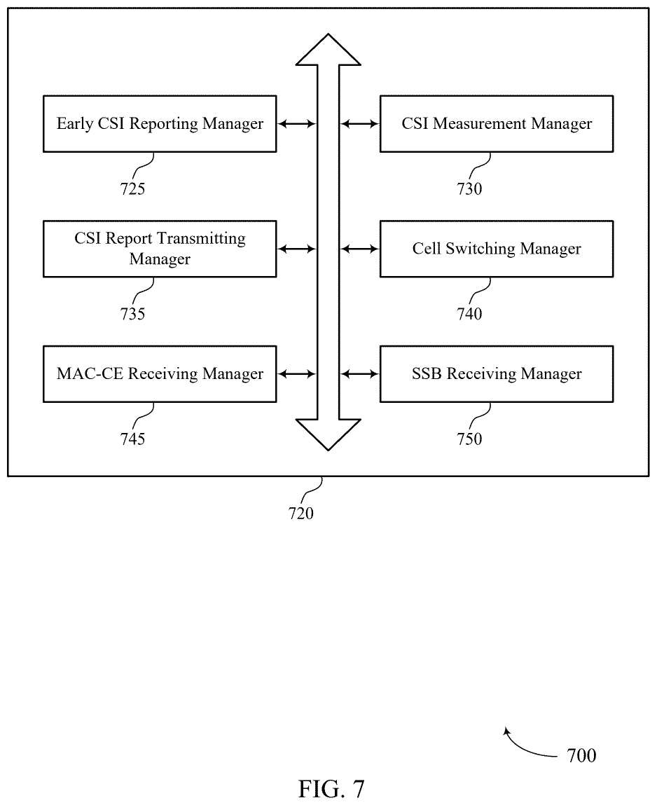

FIG. 7 shows a block diagram 700 of a communications manager 720 that supports techniques for early CSI acquisition in LTM in accordance with one or more aspects of the present disclosure. The communications manager 720 may be an example of aspects of a communications manager 520, a communications manager 620, or both, as described herein. The communications manager 720, or various components thereof, may be an example of means for performing various aspects of techniques for early CSI acquisition in LTM as described herein. For example, the communications manager 720 may include an early CSI reporting manager 725, a CSI measurement manager 730, a CSI report transmitting manager 735, a cell switching manager 740, a MAC-CE receiving manager 745, an SSB receiving manager 750, or any combination thereof. Each of these components, or components or subcomponents thereof (e.g., one or more processors, one or more memories), may communicate, directly or indirectly, with one another (e.g., via one or more buses).

The early CSI reporting manager 725 is capable of, configured to, or operable to support a means for receiving, from a first cell, a message that triggers early CSI reporting for a second cell. The CSI measurement manager 730 is capable of, configured to, or operable to support a means for performing measurements for a CSI-RS received from the second cell based on receiving the message, where the CSI-RS is received subsequent to the message in a time domain. The CSI report transmitting manager 735 is capable of, configured to, or operable to support a means for transmitting, to the first cell, the second cell, or both, a CSI report that is based on the measurements performed for the CSI-RS received from the second cell. The cell switching manager 740 is capable of, configured to, or operable to support a means for receiving, from the first cell, a cell switch command to perform a cell switching procedure from the first cell to the second cell based on the CSI report.

In some examples, a time interval between reception of the CSI-RS and transmission of the CSI report is based on a time interval between reception of a downlink message via the first cell and transmission of an additional CSI report to the first cell.

In some examples, the MAC-CE receiving manager 745 is capable of, configured to, or operable to support a means for receiving, from the first cell, a MAC-CE message that activates one or more TCI states associated with the second cell, where the CSI-RS is associated with the one or more TCI states.

In some examples, the MAC-CE receiving manager 745 is capable of, configured to, or operable to support a means for receiving, via the MAC-CE message, an indication of at least one TCI state from the one or more TCI states that is to be used for early CSI reporting for the second cell, where the CSI-RS is associated with the at least one TCI state.

In some examples, the MAC-CE receiving manager 745 is capable of, configured to, or operable to support a means for receiving, from the first cell, a second MAC-CE message, a DCI message, or both, that indicates at least one TCI state from the one or more TCI states that is to be used for early CSI reporting for the second cell, where the CSI-RS is associated with the at least one TCI state.

In some examples, the SSB receiving manager 750 is capable of, configured to, or operable to support a means for receiving a SSB from the second cell based on receiving the message that triggers early CSI reporting for the second cell, where the SSB is quasi co-located with the CSI-RS, where the CSI-RS is received based on receiving the SSB.

In some examples, the SSB is received during a time interval following reception of the message that triggers early CSI reporting. In some examples, the CSI-RS is received after an expiration of the time interval. In some examples, the time interval is associated with a processing time for the SSB at the UE.

In some examples, the CSI-RS is one of a set of multiple periodic CSI-RSs transmitted by the second cell.

In some examples, a time interval between reception of the CSI-RS and transmission of the CSI report is based on one or more capabilities associated with the UE.

In some examples, a time interval between reception of the CSI-RS and transmission of the CSI report is based on a reference signal type associated with the CSI-RS, the reference signal type including one of a periodic reference signal, an aperiodic reference signal, or a semi-persistent reference signal.

In some examples, a time interval between reception of the CSI-RS and transmission of the CSI report is based on whether the UE has received an activation command for one or more TCI states associated with the second cell.

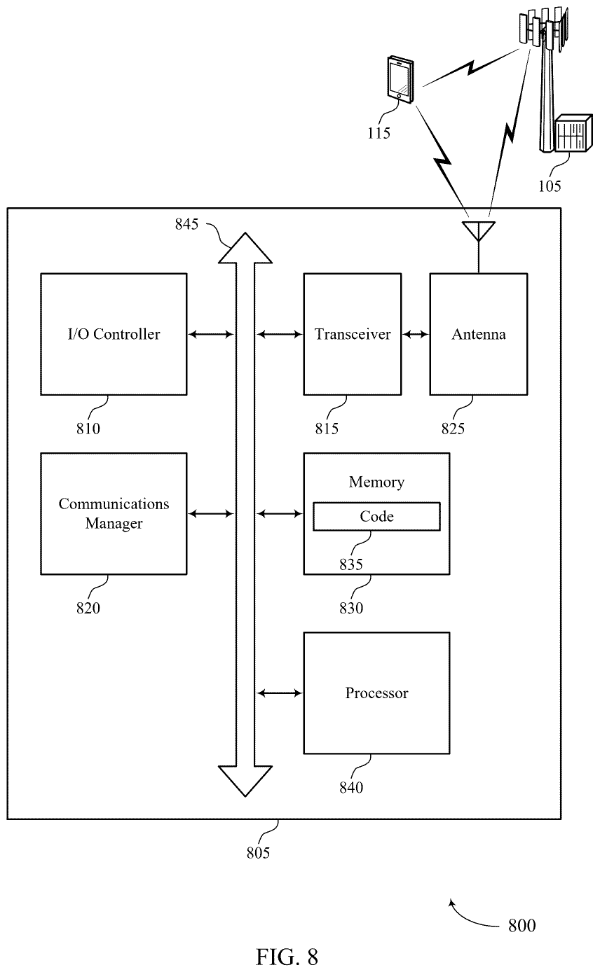

FIG. 8 shows a diagram of a system 800 including a device 805 that supports techniques for early CSI acquisition in LTM in accordance with one or more aspects of the present disclosure. The device 805 may be an example of or include components of a device 505, a device 605, or a UE 115 as described herein. The device 805 may communicate (e.g., wirelessly) with one or more other devices (e.g., network entities 105, UEs 115, or a combination thereof). The device 805 may include components for bi-directional voice and data communications including components for transmitting and receiving communications, such as a communications manager 820, an input/output (I/O) controller, such as an I/O controller 810, a transceiver 815, one or more antennas 825, at least one memory 830, code 835, and at least one processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of one or more processors, such as the at least one processor 840. In some cases, a user may interact with the device 805 via the I/O controller 810 or via hardware components controlled by the I/O controller 810.

In some cases, the device 805 may include a single antenna. However, in some other cases, the device 805 may have more than one antenna, which may be capable of concurrently transmitting or receiving multiple wireless transmissions. The transceiver 815 may communicate bi-directionally via the one or more antennas 825 using wired or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The at least one memory 830 may include random access memory (RAM) and read-only memory (ROM). The at least one memory 830 may store computer-readable, computer-executable, or processor-executable code, such as the code 835. The code 835 may include instructions that, when executed by the at least one processor 840, cause the device 805 to perform various functions described herein. The code 835 may be stored in a non-transitory computer-readable medium such as system memory or another type of memory. In some cases, the code 835 may not be directly executable by the at least one processor 840 but may cause a computer (e.g., when compiled and executed) to perform functions described herein. In some cases, the at least one memory 830 may include, among other things, a basic I/O system (BIOS) which may control basic hardware or software operation such as the interaction with peripheral components or devices.

The at least one processor 840 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 840 may be configured to operate a memory array using a memory controller. In some other cases, a memory controller may be integrated into the at least one processor 840. The at least one processor 840 may be configured to execute computer-readable instructions stored in a memory (e.g., the at least one memory 830) to cause the device 805 to perform various functions (e.g., functions or tasks supporting techniques for early CSI acquisition in LTM). For example, the device 805 or a component of the device 805 may include at least one processor 840 and at least one memory 830 coupled with or to the at least one processor 840, the at least one processor 840 and the at least one memory 830 configured to perform various functions described herein.

In some examples, the at least one processor 840 may include multiple processors and the at least one memory 830 may include multiple memories. One or more of the multiple processors may be coupled with one or more of the multiple memories, which may, individually or collectively, be configured to perform various functions described herein. In some examples, the at least one processor 840 may be a component of a processing system, which may refer to a system (such as a series) of machines, circuitry (including, for example, one or both of processor circuitry (which may include the at least one processor 840) and memory circuitry (which may include the at least one memory 830)), or components, that receives or obtains inputs and processes the inputs to produce, generate, or obtain a set of outputs. The processing system may be configured to perform one or more of the functions described herein. For example, the at least one processor 840 or a processing system including the at least one processor 840 may be configured to, configurable to, or operable to cause the device 805 to perform one or more of the functions described herein. Further, as described herein, being “configured to,” being “configurable to,” and being “operable to” may be used interchangeably and may be associated with a capability, when executing code 835 (e.g., processor-executable code) stored in the at least one memory 830 or otherwise, to perform one or more of the functions described herein.

For example, the communications manager 820 is capable of, configured to, or operable to support a means for receiving, from a first cell, a message that triggers early CSI reporting for a second cell. The communications manager 820 is capable of, configured to, or operable to support a means for performing measurements for a CSI-RS received from the second cell based on receiving the message, where the CSI-RS is received subsequent to the message in a time domain. The communications manager 820 is capable of, configured to, or operable to support a means for transmitting, to the first cell, the second cell, or both, a CSI report that is based on the measurements performed for the CSI-RS received from the second cell. The communications manager 820 is capable of, configured to, or operable to support a means for receiving, from the first cell, a cell switch command to perform a cell switching procedure from the first cell to the second cell based on the CSI report.

By including or configuring the communications manager 820 in accordance with examples as described herein, the device 805 may support techniques to facilitate more efficient cell switching procedures, and to reduce latency between UEs 115 and a new cell upon completion of a cell switching procedure. In particular, aspects of the present disclosure may enable UEs 115 to acquire CSI information from a candidate cell before and/or during an LTM switching procedure, thereby enabling the UE 115 to determine CSI information for the new cell before completing the LTM switching procedure. As such, techniques described herein may prevent the need for the UE 115 to acquire CSI information from the new cell after completion of the cell switching procedure, thereby reducing a latency of wireless communications. Further, the configuration and rules defined herein may enable UEs 115 to identify when to expect CSI-RSs from neighboring cells, and when to transmit CSI reports, thereby reducing the complexity and processing burden associated with CSI acquisition from neighboring cells. Thus, aspects of the present disclosure may reduce complexity and power consumption of the UEs 115, and improve battery life/performance.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the at least one processor 840, the at least one memory 830, the code 835, or any combination thereof. For example, the code 835 may include instructions executable by the at least one processor 840 to cause the device 805 to perform various aspects of techniques for early CSI acquisition in LTM as described herein, or the at least one processor 840 and the at least one memory 830 may be otherwise configured to, individually or collectively, perform or support such operations.

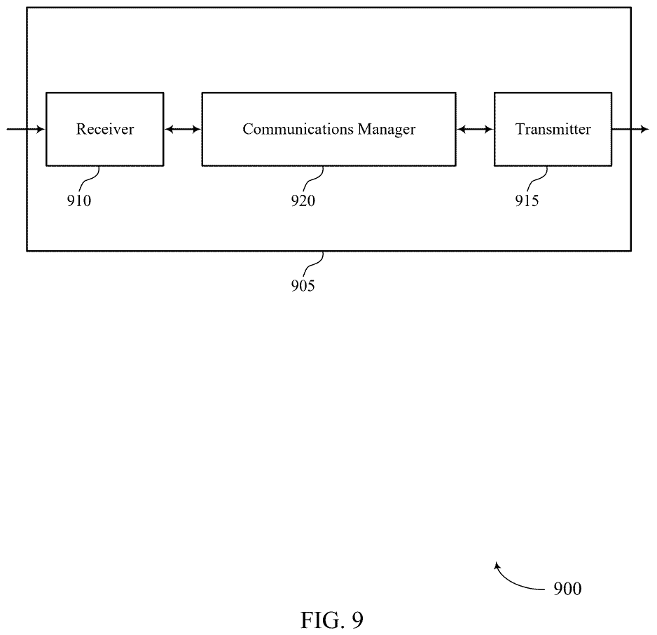

FIG. 9 shows a block diagram 900 of a device 905 that supports techniques for early CSI acquisition in LTM in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, the communications manager 920), may include at least one processor, which may be coupled with at least one memory, to, individually or collectively, support or enable the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations or components thereof may be examples of means for performing various aspects of techniques for early CSI acquisition in LTM as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 920, the receiver 910, the transmitter 915, or various combinations or components thereof may be implemented in code (e.g., as communications management software or firmware) executed by at least one processor (e.g., referred to as a processor-executable code). If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

For example, the communications manager 920 is capable of, configured to, or operable to support a means for transmitting, to a UE, a message that triggers early CSI reporting for a second cell. The communications manager 920 is capable of, configured to, or operable to support a means for transmitting, to a second cell, an indication for the second cell to transmit one or more CSI-RSs. The communications manager 920 is capable of, configured to, or operable to support a means for receiving, from the UE, a CSI report that is based on a CSI-RS of the one or more CSI-RSs that is transmitted subsequent to the message in a time domain. The communications manager 920 is capable of, configured to, or operable to support a means for transmitting, to the UE, a cell switch command to perform a cell switching procedure from the first cell to the second cell based on the CSI report.

For example, the communications manager 920 is capable of, configured to, or operable to support a means for receiving, from a first cell, a message that indicates for the second cell to transmit one or more CSI-RSs to a UE for early CSI reporting at the UE, where the message indicates a timing associated with the one or more CSI-RSs. The communications manager 920 is capable of, configured to, or operable to support a means for transmitting the one or more CSI-RSs to the UE based on receiving the message from the first cell and in accordance with the timing. The communications manager 920 is capable of, configured to, or operable to support a means for performing a cell switching procedure with the UE to switch the UE from the first cell to the second cell based on transmitting the one or more CSI-RSs.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques to facilitate more efficient cell switching procedures, and to reduce latency between UEs 115 and a new cell upon completion of a cell switching procedure. In particular, aspects of the present disclosure may enable UEs 115 to acquire CSI information from a candidate cell before and/or during an LTM switching procedure, thereby enabling the UE 115 to determine CSI information for the new cell before completing the LTM switching procedure. As such, techniques described herein may prevent the need for the UE 115 to acquire CSI information from the new cell after completion of the cell switching procedure, thereby reducing a latency of wireless communications. Further, the configuration and rules defined herein may enable UEs 115 to identify when to expect CSI-RSs from neighboring cells, and when to transmit CSI reports, thereby reducing the complexity and processing burden associated with CSI acquisition from neighboring cells. Thus, aspects of the present disclosure may reduce complexity and power consumption of the UEs 115, and improve battery life/performance.

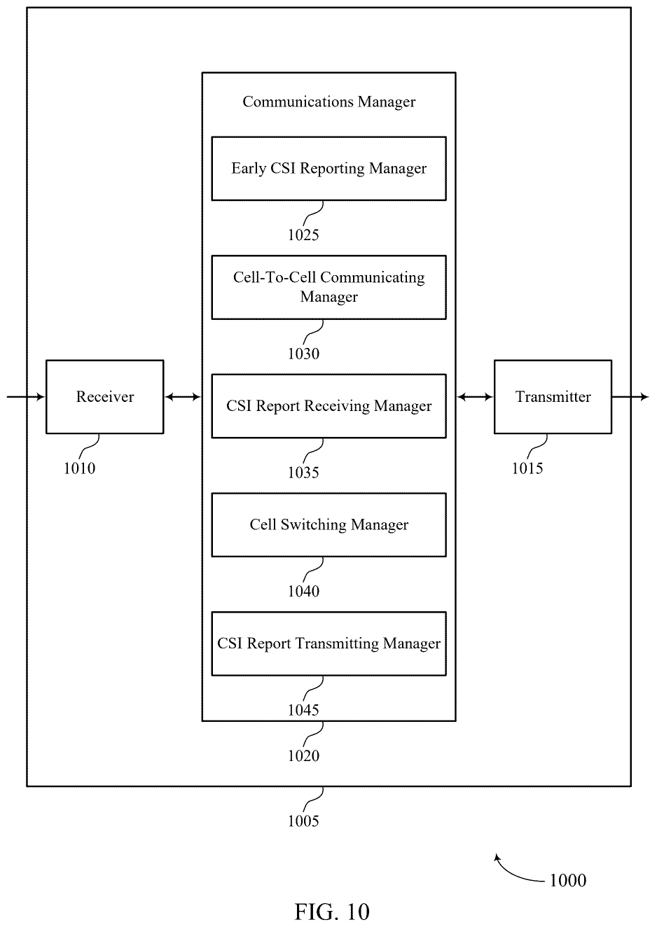

FIG. 10 shows a block diagram 1000 of a device 1005 that supports techniques for early CSI acquisition in LTM in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, the communications manager 1020), may include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of techniques for early CSI acquisition in LTM as described herein. For example, the communications manager 1020 may include an early CSI reporting manager 1025, a cell-to-cell communicating manager 1030, a CSI report receiving manager 1035, a cell switching manager 1040, a CSI report transmitting manager 1045, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The early CSI reporting manager 1025 is capable of, configured to, or operable to support a means for transmitting, to a UE, a message that triggers early CSI reporting for a second cell. The cell-to-cell communicating manager 1030 is capable of, configured to, or operable to support a means for transmitting, to a second cell, an indication for the second cell to transmit one or more CSI-RSs. The CSI report receiving manager 1035 is capable of, configured to, or operable to support a means for receiving, from the UE, a CSI report that is based on a CSI-RS of the one or more CSI-RSs that is transmitted subsequent to the message in a time domain. The cell switching manager 1040 is capable of, configured to, or operable to support a means for transmitting, to the UE, a cell switch command to perform a cell switching procedure from the first cell to the second cell based on the CSI report.

The cell-to-cell communicating manager 1030 is capable of, configured to, or operable to support a means for receiving, from a first cell, a message that indicates for the second cell to transmit one or more CSI-RSs to a UE for early CSI reporting at the UE, where the message indicates a timing associated with the one or more CSI-RSs. The CSI report transmitting manager 1045 is capable of, configured to, or operable to support a means for transmitting the one or more CSI-RSs to the UE based on receiving the message from the first cell and in accordance with the timing. The cell switching manager 1040 is capable of, configured to, or operable to support a means for performing a cell switching procedure with the UE to switch the UE from the first cell to the second cell based on transmitting the one or more CSI-RSs.

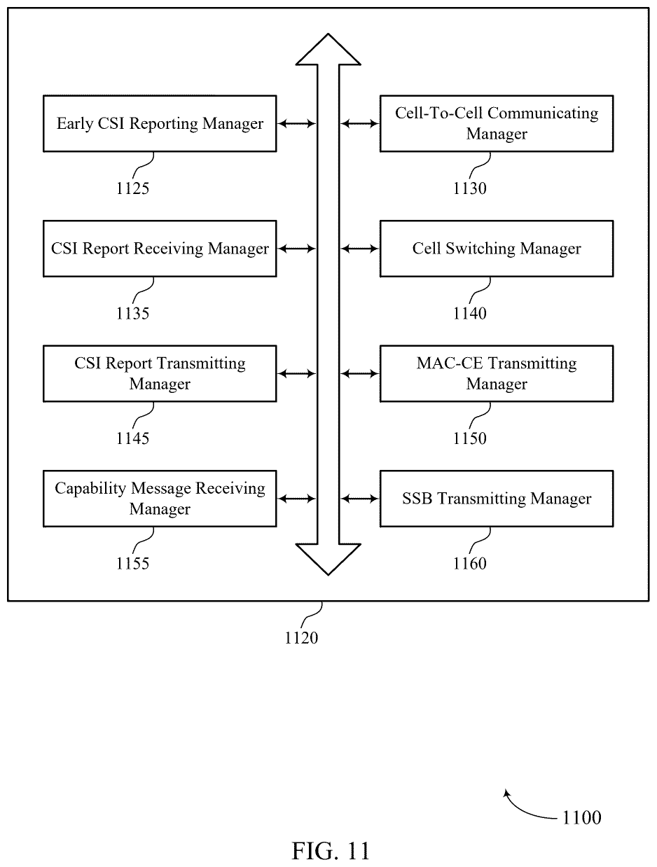

FIG. 11 shows a block diagram 1100 of a communications manager 1120 that supports techniques for early CSI acquisition in LTM in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of techniques for early CSI acquisition in LTM as described herein. For example, the communications manager 1120 may include an early CSI reporting manager 1125, a cell-to-cell communicating manager 1130, a CSI report receiving manager 1135, a cell switching manager 1140, a CSI report transmitting manager 1145, a MAC-CE transmitting manager 1150, a capability message receiving manager 1155, an SSB transmitting manager 1160, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The early CSI reporting manager 1125 is capable of, configured to, or operable to support a means for transmitting, to a UE, a message that triggers early CSI reporting for a second cell. The cell-to-cell communicating manager 1130 is capable of, configured to, or operable to support a means for transmitting, to a second cell, an indication for the second cell to transmit one or more CSI-RSs. The CSI report receiving manager 1135 is capable of, configured to, or operable to support a means for receiving, from the UE, a CSI report that is based on a CSI-RS of the one or more CSI-RSs that is transmitted subsequent to the message in a time domain. The cell switching manager 1140 is capable of, configured to, or operable to support a means for transmitting, to the UE, a cell switch command to perform a cell switching procedure from the first cell to the second cell based on the CSI report.

In some examples, a time interval between the CSI-RS and the CSI report is based on a time interval between transmission of a downlink message via the first cell and reception of an additional CSI report from the UE.

In some examples, the MAC-CE transmitting manager 1150 is capable of, configured to, or operable to support a means for transmitting, to the UE, a MAC-CE message that activates one or more TCI states associated with the second cell, where the CSI-RS is associated with the one or more TCI states.

In some examples, the MAC-CE transmitting manager 1150 is capable of, configured to, or operable to support a means for transmitting, via the MAC-CE message, an indication of at least one TCI state from the one or more TCI states that is to be used for early CSI reporting for the second cell, where the CSI-RS is associated with the at least one TCI state.

In some examples, the MAC-CE transmitting manager 1150 is capable of, configured to, or operable to support a means for transmitting, to the UE, a second MAC-CE message, a DCI message, or both, that indicates at least one TCI state from the one or more TCI states that is to be used for early CSI reporting for the second cell, where the CSI-RS is associated with the at least one TCI state.

In some examples, the capability message receiving manager 1155 is capable of, configured to, or operable to support a means for receiving, from the UE, a capability message indicating one or more capabilities associated with the UE. In some examples, the cell-to-cell communicating manager 1130 is capable of, configured to, or operable to support a means for transmitting an indication of the one or more capabilities of the UE, where a first time interval between the message that triggers early channels state information reporting and the CSI-RS, or a second time interval between the CSI-RS and the CSI report, is based on the one or more capabilities.

In some examples, a time interval between the CSI-RS and the CSI report is based on a reference signal type associated with the CSI-RS, the reference signal type including one of a periodic reference signal, an aperiodic reference signal, or a semi-persistent reference signal.

In some examples, a time interval between the CSI-RS and the CSI report is based on whether the first cell has transmitted an activation command for one or more TCI states associated with the second cell.

In some examples, the cell-to-cell communicating manager 1130 is capable of, configured to, or operable to support a means for receiving, from a first cell, a message that indicates for the second cell to transmit one or more CSI-RSs to a UE for early CSI reporting at the UE, where the message indicates a timing associated with the one or more CSI-RSs. The CSI report transmitting manager 1145 is capable of, configured to, or operable to support a means for transmitting the one or more CSI-RSs to the UE based on receiving the message from the first cell and in accordance with the timing. In some examples, the cell switching manager 1140 is capable of, configured to, or operable to support a means for performing a cell switching procedure with the UE to switch the UE from the first cell to the second cell based on transmitting the one or more CSI-RSs.

In some examples, the cell-to-cell communicating manager 1130 is capable of, configured to, or operable to support a means for receiving, from the first cell, an indication of one or more capabilities of the UE, where the timing of the one or more CSI-RSs is based on the one or more capabilities.

In some examples, the SSB transmitting manager 1160 is capable of, configured to, or operable to support a means for transmitting a SSB to the UE based on receiving the message from the first cell, where the SSB is quasi co-located with the one or more CSI-RSs, where the one or more CSI-RSs are transmitted based on transmitting the SSB.

In some examples, the one or more CSI-RSs include a set of multiple periodic CSI-RSs transmitted by the second cell.

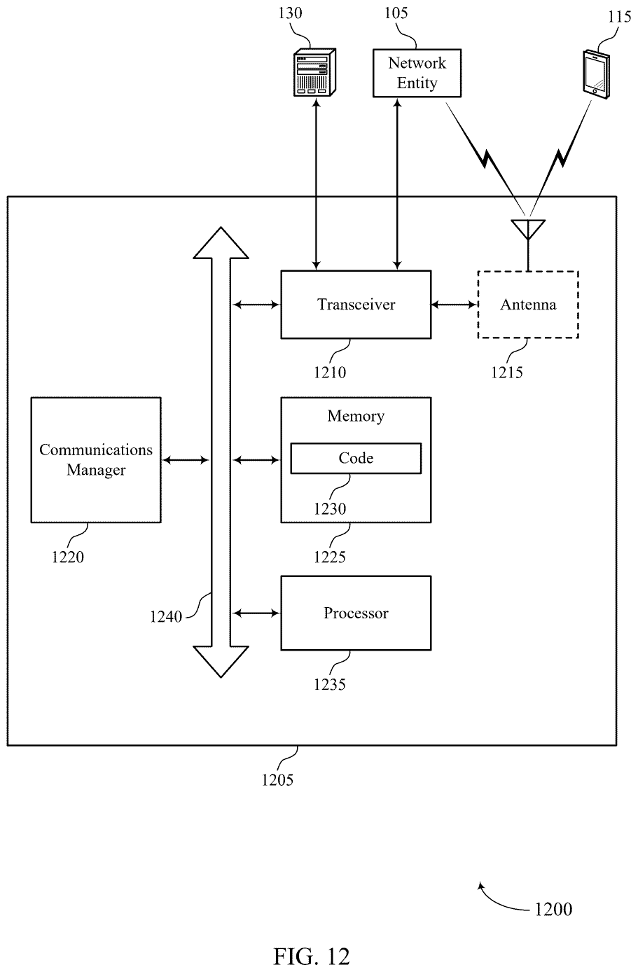

FIG. 12 shows a diagram of a system 1200 including a device 1205 that supports techniques for early CSI acquisition in LTM in accordance with one or more aspects of the present disclosure. The device 1205 may be an example of or include components of a device 905, a device 1005, or a network entity 105 as described herein. The device 1205 may communicate with other network devices or network equipment such as one or more of the network entities 105, UEs 115, or any combination thereof. The communications may include communications over one or more wired interfaces, over one or more wireless interfaces, or any combination thereof. The device 1205 may include components that support outputting and obtaining communications, such as a communications manager 1220, a transceiver 1210, one or more antennas 1215, at least one memory 1225, code 1230, and at least one processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or one or more memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or one or more memory components (e.g., the at least one processor 1235, the at least one memory 1225, or both), may be included in a chip or chip assembly that is installed in the device 1205. In some examples, the transceiver 1210 may be operable to support communications via one or more communications links (e.g., communication link(s) 125, backhaul communication link(s) 120, a midhaul communication link 162, a fronthaul communication link 168).

The at least one memory 1225 may include RAM, ROM, or any combination thereof. The at least one memory 1225 may store computer-readable, computer-executable, or processor-executable code, such as the code 1230. The code 1230 may include instructions that, when executed by one or more of the at least one processor 1235, cause the device 1205 to perform various functions described herein. The code 1230 may be stored in a non-transitory computer-readable medium such as system memory or another type of memory. In some cases, the code 1230 may not be directly executable by a processor of the at least one processor 1235 but may cause a computer (e.g., when compiled and executed) to perform functions described herein. In some cases, the at least one memory 1225 may include, among other things, a BIOS which may control basic hardware or software operation such as the interaction with peripheral components or devices. In some examples, the at least one processor 1235 may include multiple processors and the at least one memory 1225 may include multiple memories. One or more of the multiple processors may be coupled with one or more of the multiple memories which may, individually or collectively, be configured to perform various functions herein (for example, as part of a processing system).

The at least one processor 1235 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1235 may be configured to operate a memory array using a memory controller. In some other cases, a memory controller may be integrated into one or more of the at least one processor 1235. The at least one processor 1235 may be configured to execute computer-readable instructions stored in a memory (e.g., one or more of the at least one memory 1225) to cause the device 1205 to perform various functions (e.g., functions or tasks supporting techniques for early CSI acquisition in LTM). For example, the device 1205 or a component of the device 1205 may include at least one processor 1235 and at least one memory 1225 coupled with one or more of the at least one processor 1235, the at least one processor 1235 and the at least one memory 1225 configured to perform various functions described herein. The at least one processor 1235 may be an example of a cloud-computing platform (e.g., one or more physical nodes and supporting software such as operating systems, virtual machines, or container instances) that may host the functions (e.g., by executing code 1230) to perform the functions of the device 1205. The at least one processor 1235 may be any one or more suitable processors capable of executing scripts or instructions of one or more software programs stored in the device 1205 (such as within one or more of the at least one memory 1225).

In some examples, the at least one processor 1235 may include multiple processors and the at least one memory 1225 may include multiple memories. One or more of the multiple processors may be coupled with one or more of the multiple memories, which may, individually or collectively, be configured to perform various functions herein. In some examples, the at least one processor 1235 may be a component of a processing system, which may refer to a system (such as a series) of machines, circuitry (including, for example, one or both of processor circuitry (which may include the at least one processor 1235) and memory circuitry (which may include the at least one memory 1225)), or components, that receives or obtains inputs and processes the inputs to produce, generate, or obtain a set of outputs. The processing system may be configured to perform one or more of the functions described herein. For example, the at least one processor 1235 or a processing system including the at least one processor 1235 may be configured to, configurable to, or operable to cause the device 1205 to perform one or more of the functions described herein. Further, as described herein, being “configured to,” being “configurable to,” and being “operable to” may be used interchangeably and may be associated with a capability, when executing code stored in the at least one memory 1225 or otherwise, to perform one or more of the functions described herein.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the at least one memory 1225, the code 1230, and the at least one processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with one or more other network entities 105, and may include a controller or scheduler for controlling communications with UEs 115 (e.g., in cooperation with the one or more other network devices). In some examples, the communications manager 1220 may support an X2 interface within an LTE/LTE-A wireless communications network technology to provide communication between network entities 105.

For example, the communications manager 1220 is capable of, configured to, or operable to support a means for transmitting, to a UE, a message that triggers early CSI reporting for a second cell. The communications manager 1220 is capable of, configured to, or operable to support a means for transmitting, to a second cell, an indication for the second cell to transmit one or more CSI-RSs. The communications manager 1220 is capable of, configured to, or operable to support a means for receiving, from the UE, a CSI report that is based on a CSI-RS of the one or more CSI-RSs that is transmitted subsequent to the message in a time domain. The communications manager 1220 is capable of, configured to, or operable to support a means for transmitting, to the UE, a cell switch command to perform a cell switching procedure from the first cell to the second cell based on the CSI report.

For example, the communications manager 1220 is capable of, configured to, or operable to support a means for receiving, from a first cell, a message that indicates for the second cell to transmit one or more CSI-RSs to a UE for early CSI reporting at the UE, where the message indicates a timing associated with the one or more CSI-RSs. The communications manager 1220 is capable of, configured to, or operable to support a means for transmitting the one or more CSI-RSs to the UE based on receiving the message from the first cell and in accordance with the timing. The communications manager 1220 is capable of, configured to, or operable to support a means for performing a cell switching procedure with the UE to switch the UE from the first cell to the second cell based on transmitting the one or more CSI-RSs.

By including or configuring the communications manager 1220 in accordance with examples as described herein, the device 1205 may support techniques to facilitate more efficient cell switching procedures, and to reduce latency between UEs 115 and a new cell upon completion of a cell switching procedure. In particular, aspects of the present disclosure may enable UEs 115 to acquire CSI information from a candidate cell before and/or during an LTM switching procedure, thereby enabling the UE 115 to determine CSI information for the new cell before completing the LTM switching procedure. As such, techniques described herein may prevent the need for the UE 115 to acquire CSI information from the new cell after completion of the cell switching procedure, thereby reducing a latency of wireless communications. Further, the configuration and rules defined herein may enable UEs 115 to identify when to expect CSI-RSs from neighboring cells, and when to transmit CSI reports, thereby reducing the complexity and processing burden associated with CSI acquisition from neighboring cells. Thus, aspects of the present disclosure may reduce complexity and power consumption of the UEs 115, and improve battery life/performance.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, one or more of the at least one processor 1235, one or more of the at least one memory 1225, the code 1230, or any combination thereof (for example, by a processing system including at least a portion of the at least one processor 1235, the at least one memory 1225, the code 1230, or any combination thereof). For example, the code 1230 may include instructions executable by one or more of the at least one processor 1235 to cause the device 1205 to perform various aspects of techniques for early CSI acquisition in LTM as described herein, or the at least one processor 1235 and the at least one memory 1225 may be otherwise configured to, individually or collectively, perform or support such operations.

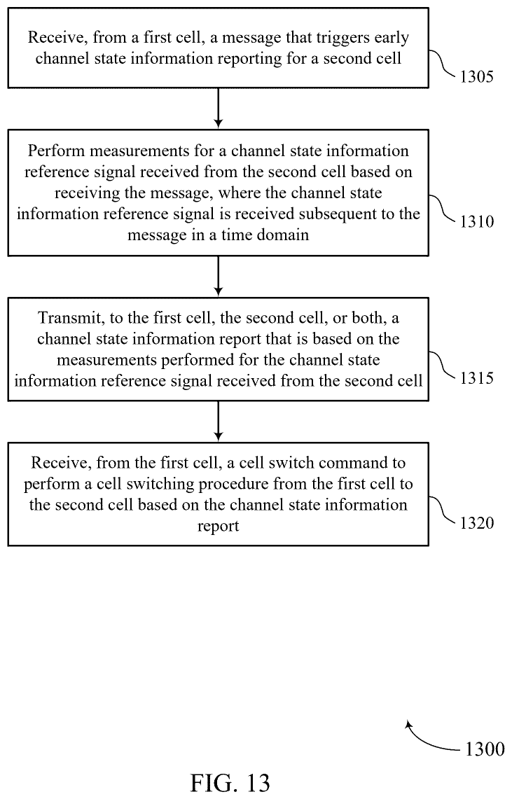

FIG. 13 shows a flowchart illustrating a method 1300 that supports techniques for early CSI acquisition in LTM in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a first cell, a message that triggers early CSI reporting for a second cell. The operations of 1305 may be performed in accordance with examples as disclosed herein. In some examples, aspects of the operations of 1305 may be performed by an early CSI reporting manager 725 as described with reference to FIG. 7.

At 1310, the method may include performing measurements for a CSI-RS received from the second cell based on receiving the message, where the CSI-RS is received subsequent to the message in a time domain. The operations of 1310 may be performed in accordance with examples as disclosed herein. In some examples, aspects of the operations of 1310 may be performed by a CSI measurement manager 730 as described with reference to FIG. 7.

At 1315, the method may include transmitting, to the first cell, the second cell, or both, a CSI report that is based on the measurements performed for the CSI-RS received from the second cell. The operations of 1315 may be performed in accordance with examples as disclosed herein. In some examples, aspects of the operations of 1315 may be performed by a CSI report transmitting manager 735 as described with reference to FIG. 7.

At 1320, the method may include receiving, from the first cell, a cell switch command to perform a cell switching procedure from the first cell to the second cell based on the CSI report. The operations of 1320 may be performed in accordance with examples as disclosed herein. In some examples, aspects of the operations of 1320 may be performed by a cell switching manager 740 as described with reference to FIG. 7.

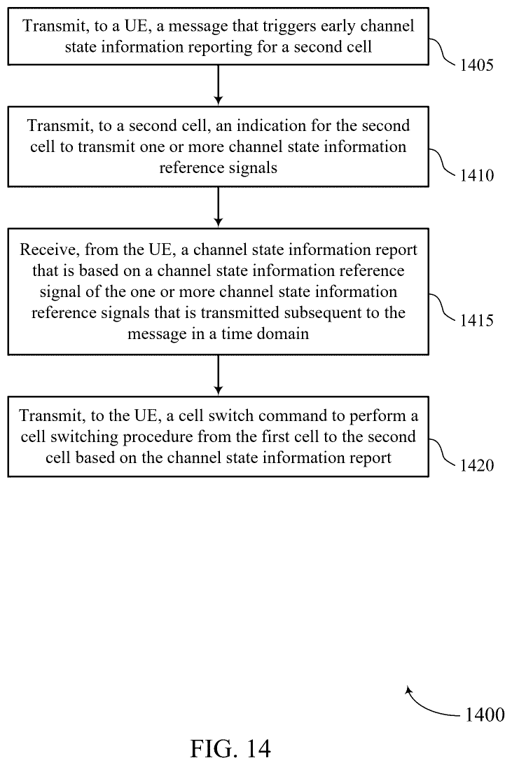

FIG. 14 shows a flowchart illustrating a method 1400 that supports techniques for early CSI acquisition in LTM in accordance with one or more aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include transmitting, to a UE, a message that triggers early CSI reporting for a second cell. The operations of 1405 may be performed in accordance with examples as disclosed herein. In some examples, aspects of the operations of 1405 may be performed by an early CSI reporting manager 1125 as described with reference to FIG. 11.

At 1410, the method may include transmitting, to a second cell, an indication for the second cell to transmit one or more CSI-RSs. The operations of 1410 may be performed in accordance with examples as disclosed herein. In some examples, aspects of the operations of 1410 may be performed by a cell-to-cell communicating manager 1130 as described with reference to FIG. 11.

At 1415, the method may include receiving, from the UE, a CSI report that is based on a CSI-RS of the one or more CSI-RSs that is transmitted subsequent to the message in a time domain. The operations of 1415 may be performed in accordance with examples as disclosed herein. In some examples, aspects of the operations of 1415 may be performed by a CSI report receiving manager 1135 as described with reference to FIG. 11.

At 1420, the method may include transmitting, to the UE, a cell switch command to perform a cell switching procedure from the first cell to the second cell based on the CSI report. The operations of 1420 may be performed in accordance with examples as disclosed herein. In some examples, aspects of the operations of 1420 may be performed by a cell switching manager 1140 as described with reference to FIG. 11.

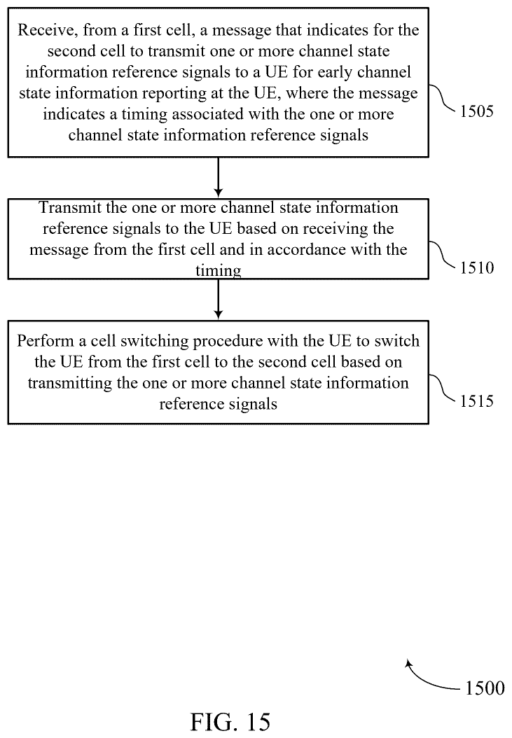

FIG. 15 shows a flowchart illustrating a method 1500 that supports techniques for early CSI acquisition in LTM in accordance with one or more aspects of the present disclosure. The operations of the method 1500 may be implemented by a network entity or its components as described herein. For example, the operations of the method 1500 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1505, the method may include receiving, from a first cell, a message that indicates for the second cell to transmit one or more CSI-RSs to a UE for early CSI reporting at the UE, where the message indicates a timing associated with the one or more CSI-RSs. The operations of 1505 may be performed in accordance with examples as disclosed herein. In some examples, aspects of the operations of 1505 may be performed by a cell-to-cell communicating manager 1130 as described with reference to FIG. 11.

At 1510, the method may include transmitting the one or more CSI-RSs to the UE based on receiving the message from the first cell and in accordance with the timing. The operations of 1510 may be performed in accordance with examples as disclosed herein. In some examples, aspects of the operations of 1510 may be performed by a CSI report transmitting manager 1145 as described with reference to FIG. 11.

At 1515, the method may include performing a cell switching procedure with the UE to switch the UE from the first cell to the second cell based on transmitting the one or more CSI-RSs. The operations of 1515 may be performed in accordance with examples as disclosed herein. In some examples, aspects of the operations of 1515 may be performed by a cell switching manager 1140 as described with reference to FIG. 11.

The following provides an overview of aspects of the present disclosure:

Aspect 1: A method for wireless communications at a UE, comprising: receiving, from a first cell, a message that triggers early CSI reporting for a second cell; performing measurements for a CSI-RS received from the second cell based at least in part on receiving the message, wherein the CSI-RS is received subsequent to the message in a time domain; transmitting, to the first cell, the second cell, or both, a CSI report that is based at least in part on the measurements performed for the CSI-RS received from the second cell; and receiving, from the first cell, a cell switch command to perform a cell switching procedure from the first cell to the second cell based at least in part on the CSI report.

Aspect 2: The method of aspect 1, wherein a time interval between reception of the CSI-RS and transmission of the CSI report is based at least in part on a time interval between reception of a downlink message via the first cell and transmission of an additional CSI report to the first cell.

Aspect 3: The method of any of aspects 1 through 2, further comprising: receiving, from the first cell, a MAC-CE message that activates one or more TCI states associated with the second cell, wherein the CSI-RS is associated with the one or more TCI states.

Aspect 4: The method of aspect 3, further comprising: receiving, via the MAC-CE message, an indication of at least one TCI state from the one or more TCI states that is to be used for early CSI reporting for the second cell, wherein the CSI-RS is associated with the at least one TCI state.

Aspect 5: The method of any of aspects 3 through 4, wherein the CSI-RS is configured for semi-persistent or aperiodic transmission, the method further comprising: receiving, via the MAC-CE message, an indication that transmission of the CSI-RS by the second cell is activated or triggered.

Aspect 6: The method of any of aspects 3 through 5, further comprising: receiving, from the first cell, a second MAC-CE message, a downlink control information message, or both, that indicates at least one TCI state from the one or more TCI states that is to be used for early CSI reporting for the second cell, wherein the CSI-RS is associated with the at least one TCI state.

Aspect 7: The method of any of aspects 1 through 6, further comprising: receiving an SSB from the second cell based at least in part on receiving the message that triggers early CSI reporting for the second cell, wherein the SSB is quasi co-located with the CSI-RS, wherein the CSI-RS is received based at least in part on receiving the SSB.

Aspect 8: The method of aspect 7, wherein the SSB is received during a time interval following reception of the message that triggers early CSI reporting, and the CSI-RS is received after an expiration of the time interval, the time interval is associated with a processing time for the SSB at the UE.

Aspect 9: The method of any of aspects 1 through 8, wherein the CSI-RS is one of a plurality of periodic CSI-RSs transmitted by the second cell.

Aspect 10: The method of any of aspects 1 through 9, wherein a time interval between reception of the CSI-RS and transmission of the CSI report is based at least in part on one or more capabilities associated with the UE.

Aspect 11: The method of any of aspects 1 through 10, wherein a time interval between reception of the CSI-RS and transmission of the CSI report is based at least in part on a reference signal type associated with the CSI-RS, the reference signal type comprising one of a periodic reference signal, an aperiodic reference signal, or a semi-persistent reference signal.

Aspect 12: The method of any of aspects 1 through 11, wherein a time interval between reception of the CSI-RS and transmission of the CSI report is based at least in part on whether the UE has received an activation command for one or more TCI states associated with the second cell.

Aspect 13: A method for wireless communications at a first cell, comprising: transmitting, to a UE, a message that triggers early CSI reporting for a second cell; transmitting, to a second cell, an indication for the second cell to transmit one or more CSI-RSs; receiving, from the UE, a CSI report that is based at least in part on a CSI-RS of the one or more CSI-RSs that is transmitted subsequent to the message in a time domain; and transmitting, to the UE, a cell switch command to perform a cell switching procedure from the first cell to the second cell based at least in part on the CSI report.

Aspect 14: The method of aspect 13, wherein a time interval between the CSI-RS and the CSI report is based at least in part on a time interval between transmission of a downlink message via the first cell and reception of an additional CSI report from the UE.

Aspect 15: The method of any of aspects 13 through 14, further comprising: transmitting, to the UE, a MAC-CE message that activates one or more TCI states associated with the second cell, wherein the CSI-RS is associated with the one or more TCI states.

Aspect 16: The method of aspect 15, further comprising: transmitting, via the MAC-CE message, an indication of at least one TCI state from the one or more TCI states that is to be used for early CSI reporting for the second cell, wherein the CSI-RS is associated with the at least one TCI state.

Aspect 17: The method of any of aspects 15 through 16, further comprising: transmitting, to the UE, a second MAC-CE message, a downlink control information message, or both, that indicates at least one TCI state from the one or more TCI states that is to be used for early CSI reporting for the second cell, wherein the CSI-RS is associated with the at least one TCI state.

Aspect 18: The method of any of aspects 13 through 17, further comprising: receiving, from the UE, a capability message indicating one or more capabilities associated with the UE; and transmitting an indication of the one or more capabilities of the UE, wherein a first time interval between the message that triggers early channels state information reporting and the CSI-RS, or a second time interval between the CSI-RS and the CSI report, is based at least in part on the one or more capabilities.

Aspect 19: The method of any of aspects 13 through 18, wherein a time interval between the CSI-RS and the CSI report is based at least in part on a reference signal type associated with the CSI-RS, the reference signal type comprising one of a periodic reference signal, an aperiodic reference signal, or a semi-persistent reference signal.

Aspect 20: The method of any of aspects 13 through 19, wherein a time interval between the CSI-RS and the CSI report is based at least in part on whether the first cell has transmitted an activation command for one or more TCI states associated with the second cell.

Aspect 21: A method for wireless communications at a second cell, comprising: receiving, from a first cell, a message that indicates for the second cell to transmit one or more CSI-RSs to a UE for early CSI reporting at the UE, wherein the message indicates a timing associated with the one or more CSI-RSs; transmitting the one or more CSI-RSs to the UE based at least in part on receiving the message from the first cell and in accordance with the timing; and performing a cell switching procedure with the UE to switch the UE from the first cell to the second cell based at least in part on transmitting the one or more CSI-RSs.

Aspect 22: The method of aspect 21, further comprising: receiving, from the first cell, an indication of one or more capabilities of the UE, wherein the timing of the one or more CSI-RSs is based at least in part on the one or more capabilities.

Aspect 23: The method of any of aspects 21 through 22, further comprising: transmitting an SSB to the UE based at least in part on receiving the message from the first cell, wherein the SSB is quasi co-located with the one or more CSI-RSs, wherein the one or more CSI-RSs are transmitted based at least in part on transmitting the SSB.

Aspect 24: The method of any of aspects 21 through 23, wherein the one or more CSI-RSs comprise a plurality of periodic CSI-RSs transmitted by the second cell.

Aspect 25: A UE comprising one or more memories storing processor-executable code, and one or more processors coupled with the one or more memories and individually or collectively operable to execute the code to cause the UE to perform a method of any of aspects 1 through 12.

Aspect 26: A UE comprising at least one means for performing a method of any of aspects 1 through 12.

Aspect 27: A non-transitory computer-readable medium storing code the code comprising instructions executable by one or more processors to perform a method of any of aspects 1 through 12.

Aspect 28: A first cell comprising one or more memories storing processor-executable code, and one or more processors coupled with the one or more memories and individually or collectively operable to execute the code to cause the first cell to perform a method of any of aspects 13 through 20.

Aspect 29: A first cell comprising at least one means for performing a method of any of aspects 13 through 20.

Aspect 30: A non-transitory computer-readable medium storing code the code comprising instructions executable by one or more processors to perform a method of any of aspects 13 through 20.

Aspect 31: A second cell comprising one or more memories storing processor-executable code, and one or more processors coupled with the one or more memories and individually or collectively operable to execute the code to cause the second cell to perform a method of any of aspects 21 through 24.

Aspect 32: A second cell comprising at least one means for performing a method of any of aspects 21 through 24.

Aspect 33: A non-transitory computer-readable medium storing code the code comprising instructions executable by one or more processors to perform a method of any of aspects 21 through 24.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, from a first cell, a message that triggers early channel state information reporting for a second cell;
perform measurements for a channel state information reference signal received from the second cell based at least in part on receiving the message, wherein the channel state information reference signal is received subsequent to the message in a time domain;
transmit, to the first cell, the second cell, or both, a channel state information report that is based at least in part on the measurements performed for the channel state information reference signal received from the second cell; and
receive, from the first cell, a cell switch command to perform a cell switching procedure from the first cell to the second cell based at least in part on the channel state information report.

2. The UE of claim 1, wherein a time interval between reception of the channel state information reference signal and transmission of the channel state information report is based at least in part on a time interval between reception of a downlink message via the first cell and transmission of an additional channel state information report to the first cell.

3. The UE of claim 1, wherein the one or more processors are individually or collectively further operable to execute the code to cause the UE to:
receive, from the first cell, a medium access control-control element message that activates one or more transmission configuration indicator states associated with the second cell, wherein the channel state information reference signal is associated with the one or more transmission configuration indicator states.

4. The UE of claim 3, wherein the one or more processors are individually or collectively further operable to execute the code to cause the UE to:
receive, via the medium access control-control element message, an indication of at least one transmission configuration indicator state from the one or more transmission configuration indicator states that is to be used for early channel state information reporting for the second cell, wherein the channel state information reference signal is associated with the at least one transmission configuration indicator state.

5. The UE of claim 3, wherein the channel state information reference signal is configured for semi-persistent or aperiodic transmission, and the one or more processors are individually or collectively further operable to execute the code to cause the UE to:
receive, via the medium access control-control element message, an indication that transmission of the channel state information reference signal by the second cell is activated or triggered.

6. The UE of claim 3, wherein the one or more processors are individually or collectively further operable to execute the code to cause the UE to:
receive, from the first cell, a second medium access control-control element message, a downlink control information message, or both, that indicates at least one transmission configuration indicator state from the one or more transmission configuration indicator states that is to be used for early channel state information reporting for the second cell, wherein the channel state information reference signal is associated with the at least one transmission configuration indicator state.

7. The UE of claim 1, wherein the one or more processors are individually or collectively further operable to execute the code to cause the UE to:
receive a synchronization signal block from the second cell based at least in part on receiving the message that triggers early channel state information reporting for the second cell, wherein the synchronization signal block is quasi co-located with the channel state information reference signal, wherein the channel state information reference signal is received based at least in part on receiving the synchronization signal block.

8. The UE of claim 7, wherein the synchronization signal block is received during a time interval following reception of the message that triggers early channel state information reporting, and wherein the channel state information reference signal is received after an expiration of the time interval, wherein the time interval is associated with a processing time for the synchronization signal block at the UE.

9. The UE of claim 1, wherein the channel state information reference signal is one of a plurality of periodic channel state information reference signals transmitted by the second cell.

10. The UE of claim 1, wherein a time interval between reception of the channel state information reference signal and transmission of the channel state information report is based at least in part on one or more capabilities associated with the UE.

11. The UE of claim 1, wherein a time interval between reception of the channel state information reference signal and transmission of the channel state information report is based at least in part on a reference signal type associated with the channel state information reference signal, the reference signal type comprising one of a periodic reference signal, an aperiodic reference signal, or a semi-persistent reference signal.

12. The UE of claim 1, wherein a time interval between reception of the channel state information reference signal and transmission of the channel state information report is based at least in part on whether the UE has received an activation command for one or more transmission configuration indicator states associated with the second cell.

13. A first cell, comprising:
one or more memories storing processor-executable code; and
one or more processors coupled with the one or more memories and individually or collectively operable to execute the code to cause the first cell to:
transmit, to a user equipment (UE), a message that triggers early channel state information reporting for a second cell;
transmit, to a second cell, an indication for the second cell to transmit one or more channel state information reference signals;
receive, from the UE, a channel state information report that is based at least in part on a channel state information reference signal of the one or more channel state information reference signals that is transmitted subsequent to the message in a time domain; and
transmit, to the UE, a cell switch command to perform a cell switching procedure from the first cell to the second cell based at least in part on the channel state information report.

14. The first cell of claim 13, wherein a time interval between the channel state information reference signal and the channel state information report is based at least in part on a time interval between transmission of a downlink message via the first cell and reception of an additional channel state information report from the UE.

15. The first cell of claim 13, wherein the one or more processors are individually or collectively further operable to execute the code to cause the first cell to:
transmit, to the UE, a medium access control-control element message that activates one or more transmission configuration indicator states associated with the second cell, wherein the channel state information reference signal is associated with the one or more transmission configuration indicator states.

16. The first cell of claim 15, wherein the one or more processors are individually or collectively further operable to execute the code to cause the first cell to:
transmit, via the medium access control-control element message, an indication of at least one transmission configuration indicator state from the one or more transmission configuration indicator states that is to be used for early channel state information reporting for the second cell, wherein the channel state information reference signal is associated with the at least one transmission configuration indicator state.

17. The first cell of claim 15, wherein the one or more processors are individually or collectively further operable to execute the code to cause the first cell to:
transmit, to the UE, a second medium access control-control element message, a downlink control information message, or both, that indicates at least one transmission configuration indicator state from the one or more transmission configuration indicator states that is to be used for early channel state information reporting for the second cell, wherein the channel state information reference signal is associated with the at least one transmission configuration indicator state.

18. The first cell of claim 13, wherein the one or more processors are individually or collectively further operable to execute the code to cause the first cell to:
receive, from the UE, a capability message indicating one or more capabilities associated with the UE; and
transmit an indication of the one or more capabilities of the UE, wherein a first time interval between the message that triggers early channels state information reporting and the channel state information reference signal, or a second time interval between the channel state information reference signal and the channel state information report, is based at least in part on the one or more capabilities.

19. The first cell of claim 13, wherein a time interval between the channel state information reference signal and the channel state information report is based at least in part on a reference signal type associated with the channel state information reference signal, the reference signal type comprising one of a periodic reference signal, an aperiodic reference signal, or a semi-persistent reference signal.

20. A method for wireless communications at a user equipment (UE), comprising:
receiving, from a first cell, a message that triggers early channel state information reporting for a second cell;
performing measurements for a channel state information reference signal received from the second cell based at least in part on receiving the message, wherein the channel state information reference signal is received subsequent to the message in a time domain;
transmitting, to the first cell, the second cell, or both, a channel state information report that is based at least in part on the measurements performed for the channel state information reference signal received from the second cell; and
receiving, from the first cell, a cell switch command to perform a cell switching procedure from the first cell to the second cell based at least in part on the channel state information report.
